(19) United States
(12) Patent Application Publication
(10) Pub. No.: US 2025/0385605 A1
(43) Pub. Date: Dec. 18, 2025

(54) POWER SUPPLY CONTROL DEVICE AND SWITCHING POWER SUPPLY APPARATUS

(71) Applicant: ROHM Co., LTD., Kyoto (JP)

(72) Inventor: Kenichi Okajima, Kyoto (JP)

(21) Appl. No.: 19/206,452

(22) Filed: May 13, 2025

(30) Foreign Application Priority Data
Jun. 14, 2024 (JP) 2024-096553

(51) Int. Cl. H02M 3/155; H02M 1/14

(52) U.S. Cl. CPC H02M 3/155; H02M 1/143

(57) ABSTRACT

Provided is a power supply control device for use in a switching power supply apparatus configured to generate a plurality of switch voltages having a rectangular wave shape at switch terminals of a plurality of channels by individually switching an input voltage by using output stage circuits of the plurality of channels, the output stage circuits each including an output transistor, and generate an output voltage by rectifying and smoothing the plurality of switch voltages, the power supply control device including an error voltage generating circuit, a ramp voltage generating circuit, a comparing circuit, and a switching control circuit.

### CROSS REFERENCE TO RELATED APPLICATIONS

This application claims priority benefit of Japanese Patent Application No. JP 2024-096553 filed in the Japan Patent Office on Jun. 14, 2024. Each of the above-referenced applications is hereby incorporated herein by reference in its entirety.

### BACKGROUND

The present disclosure relates to a power supply control device and a switching power supply apparatus.

An on-time control system is known as a control system that can achieve a high-speed load response characteristic in a switching power supply apparatus (see Japanese Patent Laid-open No. 2020-108189). The control system is often implemented in combination with a technology referred to as ripple injection. This makes it possible to use a laminated ceramic capacitor having a low equivalent series resistance (ESR) or the like as an output capacitor. On the other hand, a switching power supply apparatus having direct current to direct current (DC/DC) converters for a plurality of channels can perform multi-phase control.

An example of the related art is disclosed in Japanese Patent Laid-open No. 2020-108189.

### BRIEF DESCRIPTION OF THE DRAWINGS

FIG. 1 is a diagram of a general configuration of a switching power supply apparatus according to a first reference configuration;

FIG. 2 is a timing diagram of the switching power supply apparatus according to the first reference configuration;

FIG. 3 is a diagram of a general configuration of a power supply device according to a second reference configuration;

FIG. 4 is a timing diagram of a switching power supply apparatus according to the second reference configuration;

FIG. 5 is a timing diagram of the switching power supply apparatus according to the second reference configuration;

FIG. 6 is a diagram of a general configuration of a switching power supply apparatus according to a first embodiment of the present disclosure;

FIG. 7 is a diagram of a general configuration of the switching power supply apparatus according to the first embodiment of the present disclosure;

FIG. 8 is a timing diagram of the switching power supply apparatus according to the first embodiment of the present disclosure;

FIG. 9 is a timing diagram of the switching power supply apparatus according to the first embodiment of the present disclosure (n=2);

FIG. 10 is a diagram of a general configuration of a switching power supply apparatus according to a second embodiment of the present disclosure;

FIG. 11 relates to the second embodiment of the present disclosure and is an external perspective view of a semiconductor device forming a power supply control device;

FIG. 12 relates to the second embodiment of the present disclosure and is a timing diagram related to generation of a comparison signal;

FIG. 13 relates to the second embodiment of the present disclosure and is a timing diagram of an operation of responding to an odd-numbered rise edge in the comparison signal;

FIG. 14 relates to the second embodiment of the present disclosure and is a timing diagram of an operation of responding to the odd-numbered rise edge in the comparison signal;

FIG. 15 relates to the second embodiment of the present disclosure and is a timing diagram of an operation of responding to an even-numbered rise edge in the comparison signal;

FIG. 16 relates to the second embodiment of the present disclosure and is a timing diagram of an operation of responding to the even-numbered rise edge in the comparison signal;

FIG. 17 relates to the second embodiment of the present disclosure and is a timing diagram of the power supply control device;

FIG. 18 relates to an example EX2_1 belonging to the second embodiment of the present disclosure and is a diagram illustrating connection relations between drivers and the like in a case where the number of channels is three;

FIG. 19 relates to an example EX2_2 belonging to the second embodiment of the present disclosure and is a diagram of assistance in explaining a modified technology related to an inclination of a slope voltage;

FIG. 20 is a diagram of a general configuration of a switching power supply apparatus according to a third embodiment of the present disclosure;

FIG. 21 relates to the third embodiment of the present disclosure and is an external perspective view of two semiconductor devices forming a power supply control device;

FIG. 22 relates to the third embodiment of the present disclosure and is a timing diagram of an operation of responding to an odd-numbered rise edge in the comparison signal;

FIG. 23 relates to the third embodiment of the present disclosure and is a timing diagram of an operation of responding to the odd-numbered rise edge in the comparison signal;

FIG. 24 relates to the third embodiment of the present disclosure and is a timing diagram of an operation of responding to an even-numbered rise edge in the comparison signal;

FIG. 25 relates to the third embodiment of the present disclosure and is a timing diagram of an operation of responding to the even-numbered rise edge in the comparison signal;

FIG. 26 relates to the third embodiment of the present disclosure and is a timing diagram of the power supply control device;

FIG. 27 relates to an example EX3_1 belonging to the third embodiment of the present disclosure and is a diagram illustrating connection relations between drivers and the like in a case where the number of channels is three;

FIG. 28 relates to an example EX3_2 belonging to the third embodiment of the present disclosure and is a diagram of assistance in explaining a modified technology related to an inclination of a slope voltage;

FIG. 29 relates to a fourth embodiment of the present disclosure and is a diagram of assistance in explaining a modified technology related to a changing direction of a voltage; and

FIG. 30 relates to the fourth embodiment of the present disclosure and is a diagram of a modified configuration of a switching power supply apparatus.

### DETAILED DESCRIPTION

Prior to a description of switching power supply apparatuses according to embodiments of the present disclosure, switching power supply apparatuses according to first and second reference configurations will be described.

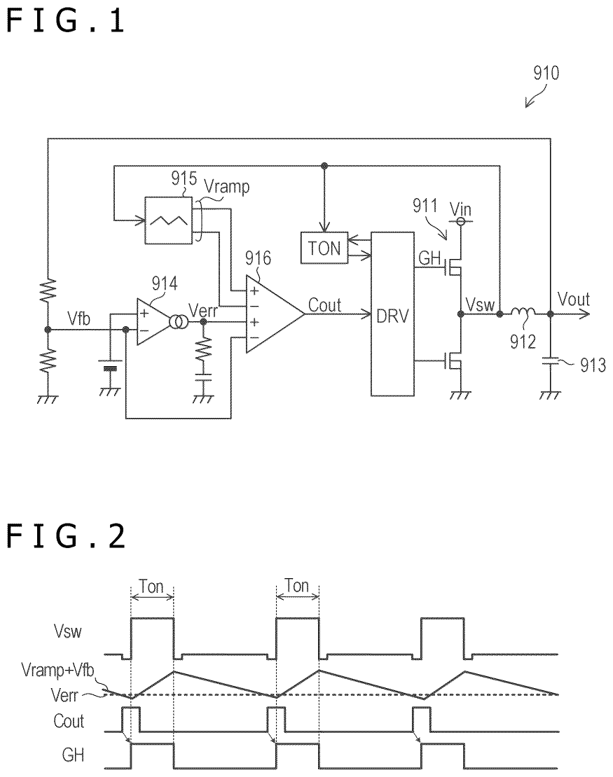

FIG. 1 illustrates a switching power supply apparatus 910 according to a first reference configuration. The switching power supply apparatus 910 is a step-down switching power supply apparatus that adopts an on-time control system. FIG. 2 illustrates a timing diagram of the switching power supply apparatus 910. The switching power supply apparatus 910 is provided with an output stage circuit 911, which is a series circuit of a high-side transistor (output transistor) and a low-side transistor (synchronous rectifying transistor). The switching power supply apparatus 910 generates a switch voltage Vsw having a rectangular wave shape by switching an input voltage Vin by the output stage circuit 911, and obtains an output voltage Vout by rectifying and smoothing the switch voltage Vsw by a coil 912 and an output capacitor 913. In the switching power supply apparatus 910, an error amplifier 914 generates an error voltage Verr on the basis of an error between a feedback voltage Vfb corresponding to the output voltage Vout and a reference voltage, while a ramp voltage generating circuit 915 generates a ramp voltage Vramp that varies in synchronism with the switch voltage Vsw. In the switching power supply apparatus 910, the ramp voltage Vramp monotonically rises in a high level period of the switch voltage Vsw (period in which the switch voltage Vsw has substantially the level of the input voltage Vin), and the ramp voltage Vramp monotonically decreases in a low level period of the switch voltage Vsw (period in which the switch voltage Vsw has substantially a level of 0 V).

A comparator 916 in the switching power supply apparatus 910 generates a comparison signal Cout that has a low level during a period during which “Vramp+Vfb>Verr” holds, and has a high level during a period during which “Vramp+Vfb<Verr” holds. In the switching power supply apparatus 910, each time the level of the comparison signal Cout changes from a low level to a high level, a gate signal GH of the high-side transistor is set at a high level for an on time Ton. A state is thereby realized in which the high-side transistor is on and the low-side transistor is off for the on time Ton. In the switching power supply apparatus 910, the on time Ton may be determined according to the switch voltage Vsw.

The switching power supply apparatus 910 operates such that the output voltage Vout is stabilized at a predetermined target voltage. In the switching power supply apparatus 910, variance of the output voltage Vout from the target voltage is detected, and the comparison signal Cout is generated such that the output voltage Vout swiftly goes to the target voltage when the variance occurs. For stable operation of the comparator 916, a ripple of an input voltage to the comparator 916 needs to be reasonably large. If the ramp voltage generating circuit 915 is not provided, in a case where the output capacitor 913 is formed by a ceramic capacitor having a sufficiently low equivalent series resistance or the like, the above-described ripples are insufficient, and consequently the stable operation is impaired. The provision of the ramp voltage generating circuit 915 enables a stable operation of the comparator 916 even when the output capacitor 913 is formed by a ceramic capacitor or the like.

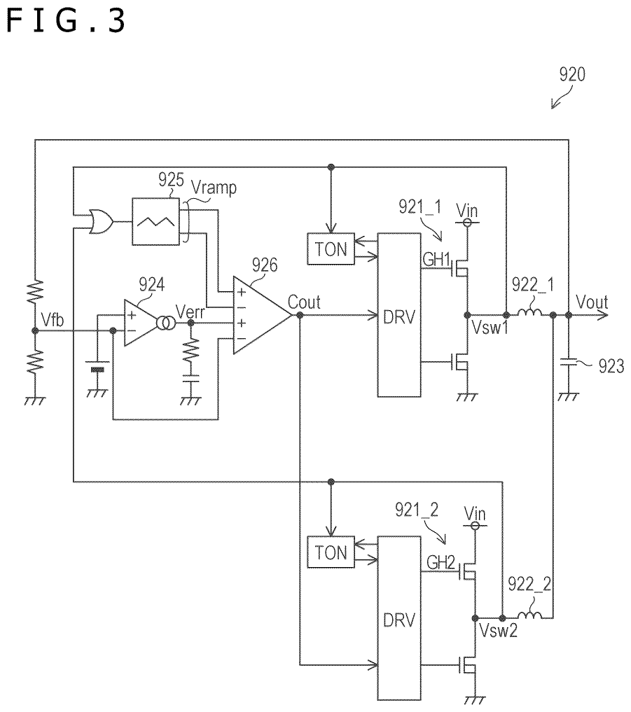

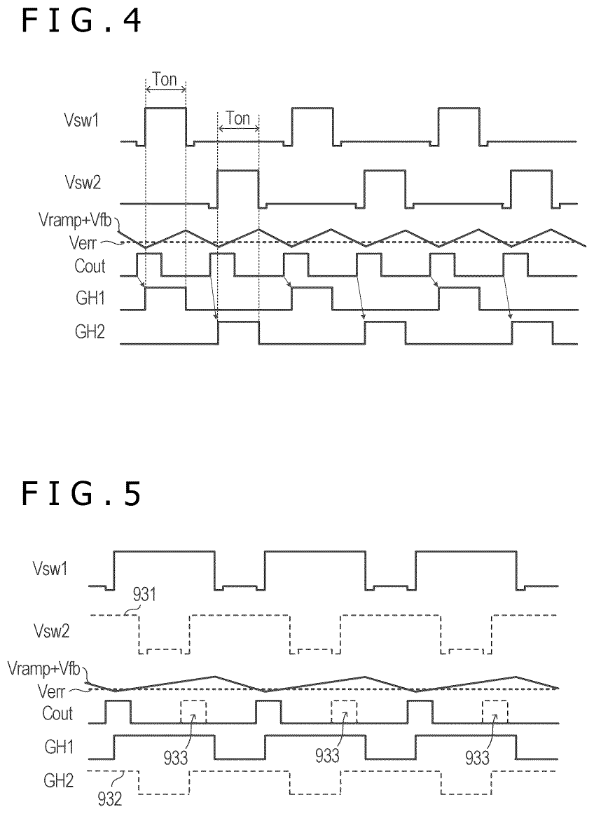

FIG. 3 illustrates a switching power supply apparatus 920 according to a second reference configuration. As with the switching power supply apparatus 910 in FIG. 1, the switching power supply apparatus 920 is a step-down switching power supply apparatus that adopts the on-time control system. However, the switching power supply apparatus 920 is provided with output stage circuits 921_1 and 921_2 for two channels as output stage circuits formed by a series circuit of a high-side transistor (output transistor) and a low-side transistor (synchronous rectifying transistor), and performs multi-phase control. FIG. 4 illustrates a timing diagram of the switching power supply apparatus 920. The switching power supply apparatus 920 generates switch voltages Vsw1 and Vsw2 having a rectangular wave shape by individually switching the input voltage Vin by the output stage circuits 921_1 and 921_2, and obtains an output voltage Vout by rectifying and smoothing the switch voltages Vsw1 and Vsw2 by coils 922_1 and 922_2 and an output capacitor 923. In the switching power supply apparatus 920, an error amplifier 924 generates an error voltage Verr on the basis of an error between the feedback voltage Vfb corresponding to the output voltage Vout and a reference voltage, while a ramp voltage generating circuit 925 generates a ramp voltage Vramp that varies in synchronism with the switch voltage Vsw1 or Vsw2. The ramp voltage generating circuit 925 monotonically raises the ramp voltage Vramp in a period in which at least one of the switch voltages Vsw1 and Vsw2 has a high level (substantially the level of the input voltage Vin), and monotonically decreases the ramp voltage Vramp in a period in which both of the switch voltages Vsw1 and Vsw2 have a low level (substantially a level of 0 V).

A comparator 926 in the switching power supply apparatus 920 generates a comparison signal Cout that has a low level during a period during which “Vramp+Vfb>Verr” holds, and has a high level during a period during which “Vramp+Vfb<Verr” holds. In response to switching of the level of the comparison signal Cout from a low level to a high level, the switching power supply apparatus 920 alternately performs an operation of setting a gate signal GH1 of the high-side transistor of the output stage circuit 921_1 to a high level for the on time Ton and an operation of setting a gate signal GH2 of the high-side transistor of the output stage circuit 921_2 to a high level for the on time Ton.

FIG. 4 assumes a situation in which a sum of the on duty of a first channel and the on duty of a second channel is less than 100%. In the switching power supply apparatus 920, the on duty of the first channel is a ratio of the on period of the high-side transistor of the output stage circuit 921_1 to a sum of the on period of the high-side transistor and the on period of the low-side transistor of the output stage circuit 921_1. In the switching power supply apparatus 920, the on duty of the second channel is a ratio of the on period of the high-side transistor of the output stage circuit 921_2 to a sum of the on period of the high-side transistor and the on period of the low-side transistor of the output stage circuit 921_2.

The switching power supply apparatus 920 does not operate properly in an imaginary case in which the sum of the on duty of the first channel and the on duty of the second channel is equal to or more than 100%. FIG. 5 illustrates an imaginary timing diagram of the switching power supply apparatus 920 for the imaginary case. In the imaginary case, the on duties of the first and second channels are both larger than 50%. Broken line waveforms 931 and 932 in FIG. 5 represent the waveforms of the switch voltage Vsw2 and the gate signal GH2 that would be observed if the switching power supply apparatus 920 operated properly in the imaginary case. However, in the imaginary case, in actuality, the ramp voltage Vramp continues rising during the high level period of the switch voltage Vsw1, and therefore the comparison signal Cout does not change to a high level in timing in which the gate signal GH2 is to be changed to a high level (a broken line waveform 933 in the comparison signal Cout does not occur in FIG. 5). As a result, in the switching power supply apparatus 920, proper control is not feasible when the sum of the on duty of the first channel and the on duty of the second channel is equal to or more than 100%.

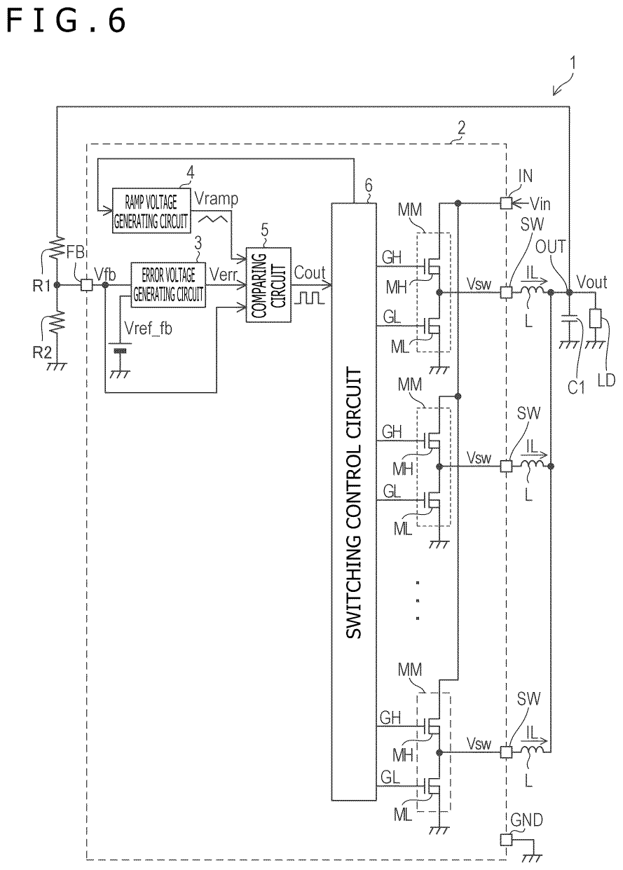

Embodiments of the present disclosure in view of these circumstances will be illustrated in the following. In figures to be referred to in the embodiments of the present disclosure, identical parts are identified by the same reference signs, and repeated description of the identical parts will be omitted in principle. Incidentally, in the present specification, for the simplification of description, the names of information, signals, physical quantities, functional units, circuits, elements, parts, or the like corresponding to symbols or reference signs may be omitted or abbreviated by writing the symbols or the reference signs that refer to the information, the signals, the physical quantities, the functional units, the circuits, the elements, the parts, or the like. For example, a comparison signal referred to by “Cout” (see FIG. 6), which will be described later, may be written as a comparison signal Cout, or can be abbreviated as a signal Cout. However, these each indicate the same signal.

Description will be provided for several terms used in describing the embodiments of the present disclosure. A ground refers to a reference conductor having a potential of 0 V (zero volts) serving as a reference, or refers to the potential of 0 V itself. The reference conductor may be formed by using a conductor of a metal or the like. The potential of 0 V may be referred to as a ground potential. In the embodiments of the present disclosure, a voltage illustrated without being particularly provided with a reference represents a potential as viewed from the ground. A level refers to the level (height) of a potential. A high level of an optional signal or voltage of interest has a potential higher than a low level. In an optional signal or voltage of interest, switching from a low level to a high level may be referred to as a rise edge, and switching from a high level to a low level may be referred to as a fall edge.

With regard to an optional transistor configured as a field effect transistor (FET) exemplified by a MOSFET, an on state refers to a state in which there is conduction between the drain and source of the transistor, and an off state refers to a state in which there is no conduction between the drain and source of the transistor (interrupted state). The same is true for transistors not classified as a FET. Unless otherwise specified, a MOSFET is construed as an enhancement-type MOSFET. The MOSFET is an abbreviation of “metal-oxide-semiconductor field-effect transistor.” In addition, unless otherwise specified, in an optional MOSFET, a back gate may be considered to be short-circuited to a source.

In the following, with regard to an optional transistor, an on state and an off state may be expressed simply as on and off. In addition, with regard to an optional transistor, a period for which the transistor is set in an on state will be referred to as an on period, and a period for which the transistor is set in an off state will be referred to as an off period.

With regard to an optional signal having a signal level of a high level or a low level, a period for which the level of the signal is set to a high level will be referred to as a high level period, and a period for which the level of the signal is set to a low level will be referred to as a low level period. The same is true for an optional voltage having a voltage level of a high level or a low level.

Unless otherwise specified, a connection between a plurality of parts forming a circuit, such as optional circuit elements, wires, or nodes may be construed as referring to an electric connection.

Supposing that two optional voltages to be compared with each other are voltages v1 and v2, “v1>v2” denotes that the voltage v1 is higher than the voltage v2, “v1<v2” denotes that the voltage v1 is lower than the voltage v2, and “v1=v2” denotes that the value of the voltage v1 is the same as the value of the voltage v2. The same is true for other expressions including physical quantities other than voltages.

### First Embodiment

A first embodiment of the present disclosure will be described. FIG. 6 illustrates a general configuration of a switching power supply apparatus 1 according to the first embodiment of the present disclosure. The switching power supply apparatus 1 is supplied with a positive input voltage Vin from a voltage source not illustrated, and generates an output voltage Vout by subjecting the input voltage Vin to power conversion. Here, the switching power supply apparatus 1 is assumed to be a step-down switching power supply apparatus. The output voltage Vout is therefore lower than the input voltage Vin. The switching power supply apparatus 1 stabilizes the output voltage Vout at a target voltage Vtg having a predetermined positive direct-current voltage value. Hence, in a steady state, the output voltage Vout substantially coincides with the target voltage Vtg. The switching power supply apparatus 1 has n DC/DC converters. The n DC/DC converters are formed by DC/DC converters of first to nth channels. n denotes an optional integer of two or more.

The switching power supply apparatus 1 includes a power supply control device 2 that controls an operation of the switching power supply apparatus 1 and a plurality of discrete parts externally connected to the power supply control device 2. The power supply control device 2 and the plurality of discrete parts form the DC/DC converters of the first to nth channels. The above-described plurality of discrete parts include coils L for the n channels, an output capacitor C1, and feedback resistances R1 and R2. The output capacitor C1 may be a capacitor of an optional kind. The output capacitor C1 may be formed by a ceramic capacitor having a sufficiently low equivalent series resistance or the like.

The power supply control device 2 is provided with an error voltage generating circuit 3, a ramp voltage generating circuit 4, a comparing circuit 5, and a switching control circuit 6. In addition, the power supply control device 2 is provided with output stage circuits MM for the n channels. However, the output stage circuits MM for the n channels may be provided outside the power supply control device 2 and connected to the power supply control device 2.

The DC/DC converters of the respective channels each include one output stage circuit MM and one coil L. The error voltage generating circuit 3, the ramp voltage generating circuit 4, and the comparing circuit 5 are shared between the first to nth channels (shared by the DC/DC converters of the first to nth channels). The switching control circuit 6 controls the state of the output stage circuit MM of each channel.

The power supply control device 2 has an input terminal IN, a ground terminal GND, and a feedback terminal FB, and has switch terminals SW provided for the respective channels. Hence, the power supply control device 2 is provided with a total of n switch terminals SW corresponding to the first to nth channels. The input terminal IN is supplied with the input voltage Vin from the voltage source not illustrated. The ground terminal GND is connected to a ground.

The output stage circuit MM in each channel includes a series circuit of a transistor MH as a high-side transistor and a transistor ML as a low-side transistor. A first end of the coil L in each channel is connected to the corresponding switch terminal SW. Second ends of the coils L in all of the channels are commonly connected to an output terminal OUT. A voltage generated at the output terminal OUT is the output voltage Vout.

The output capacitor C1 is inserted between the output terminal OUT and the ground. That is, a first terminal of the output capacitor C1 is connected to the output terminal OUT, and a second terminal of the output capacitor C1 is connected to the ground. A load LD is connected to the output terminal OUT. The load LD is an optional load driven on the basis of the output voltage Vout. A current supplied from the output terminal OUT to the load LD (that is, an output current of the switching power supply apparatus 1) will be referred to as a load current. In addition, in each coil L, a current flowing through the coil L will be referred to as a coil current IL.

A first terminal of the feedback resistance R1 is connected to the output terminal OUT. A second terminal of the feedback resistance R1 is connected to a first terminal of the feedback resistance R2. A second terminal of the feedback resistance R2 is connected to the ground. A feedback voltage Vfb corresponding to the output voltage Vout occurs at a connection node between the feedback resistances R1 and R2. The feedback terminal FB is connected to the connection node between the feedback resistances R1 and R2 and receives the feedback voltage Vfb. The feedback voltage Vfb is a divided voltage of the output voltage Vout and is therefore proportional to the output voltage Vout. The feedback resistances R1 and R2 form a feedback voltage generating circuit that generates the feedback voltage Vfb. The feedback resistances R1 and R2 can be included in the power supply control device 2. Incidentally, the output voltage Vout itself may be set as the feedback voltage Vfb. In any case, the feedback voltage Vfb is a voltage corresponding to the output voltage Vout.

The feedback voltage Vfb is input to the error voltage generating circuit 3. In addition, a reference voltage Vref_fb for feedback control is input to the error voltage generating circuit 3. The reference voltage Vref_fb is generated within the power supply control device 2 on the basis of the input voltage Vin and has a predetermined positive direct-current voltage value. The reference voltage Vref_fb may be generated by a voltage source within the error voltage generating circuit 3. The error voltage generating circuit 3 compares the feedback voltage Vfb with the reference voltage Vref_fb, and generates and outputs an error voltage Verr, which is a voltage signal corresponding to an error between the feedback voltage Vfb and the reference voltage Vref_fb.

The ramp voltage generating circuit 4 generates and outputs a ramp voltage Vramp that alternately repeats rising and decreasing. That is, the voltage value of the ramp voltage Vramp alternately repeats rising and decreasing. The ramp voltage generating circuit 4 monotonically raises the ramp voltage Vramp at a predetermined and fixed raising rate in a raising period of the ramp voltage Vramp (that is, a period in which the ramp voltage Vramp is raised), and monotonically decreases the ramp voltage Vramp at a predetermined and fixed decreasing rate in a decreasing period of the ramp voltage Vramp (that is, a period in which the ramp voltage Vramp is decreased). The timing of switching a changing direction of the ramp voltage Vramp is controlled by the switching control circuit 6 (details will be described later).

The comparing circuit 5 generates and outputs a comparison signal Cout on the basis of a level relation between two voltages based on the error voltage Verr, the ramp voltage Vramp, and the feedback voltage Vfb. The comparison signal Cout is a binary signal having an active level or a non-active level.

The switching control circuit 6 performs switching control of each of the output stage circuits MM on the basis of the comparison signal Cout. At this time, the switching control circuit 6 performs multi-phase control that shifts the phase of the switching control between the plurality of channels.

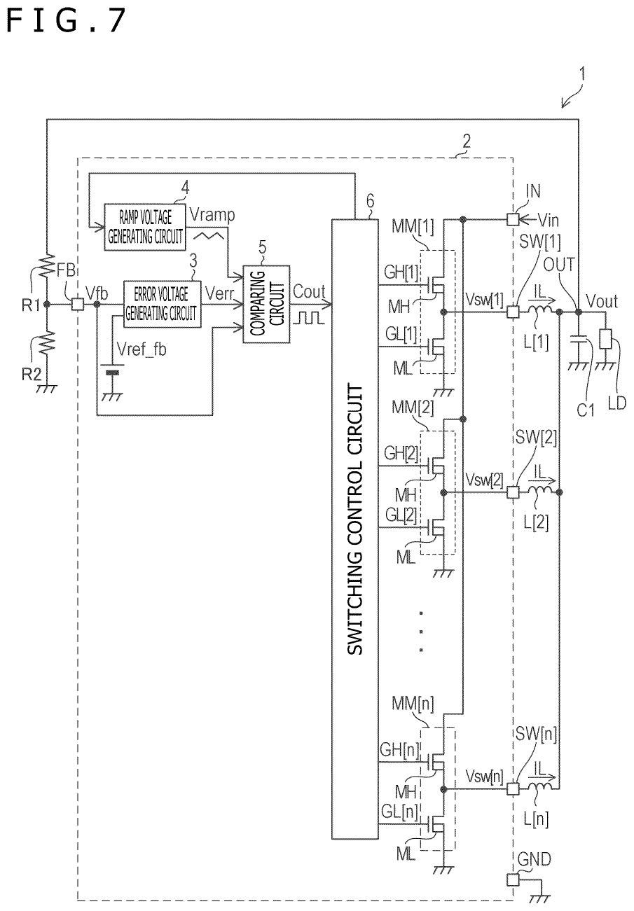

In the following, as illustrated in FIG. 7, when the n output stage circuits MM are to be distinguished from each other, the n output stage circuits MM will be referred to as output stage circuits MM[1] to MM[n]. Similarly, the n switch terminals SW may be referred to as switch terminals SW[1] to SW[n], and the n coils L may be referred to as coils L[1] to L[n]. An output stage circuit MM[i], a switch terminal SW[i], and a coil L[i] are an output stage circuit MM, a switch terminal SW, and a coil L in the DC/DC converter of an ith channel. i denotes an optional integer. In a case where i is used as a variable indicating one of the channels, i denotes an optional natural number of n or less.

The output stage circuits MM of all of the channels have a mutually same configuration. As described above, each output stage circuit MM has transistors MH and ML. The transistors MH and ML are N-channel MOSFETs. In each output stage circuit MM, the transistors MH and ML are a pair of switching elements connected in series with each other between the input terminal IN and the ground terminal GND (in other words, the ground). The transistor MH is provided on a high potential side of the transistor ML. Specifically, in each output stage circuit MM, a drain of the transistor MH is connected to the input terminal IN, and is supplied with the input voltage Vin. In each output stage circuit MM, a source of the transistor MH and a drain of the transistor ML are commonly connected to the corresponding switch terminal SW. Hence, the source of the transistor MH and the drain of the transistor ML in the output stage circuit MM[i] are commonly connected to the switch terminal SW[i]. In each output stage circuit MM, a source of the transistor ML is connected to the ground terminal GND (hence, the ground). Incidentally, a resistance for current detection may be inserted between the source of the transistor ML and the ground terminal GND.

The transistor MH functions as an output element (output transistor). The transistor ML functions as a rectifying element (synchronous rectifying transistor). In the switching control of the output stage circuit MM, the output element (MH) and the rectifying element (ML) are alternately turned on and off.

In each output stage circuit MM, when the transistors MH and ML are alternately turned on and off by the switching control, the input voltage Vin is switched, and as a result, a switch voltage Vsw having a rectangular wave shape appears at the corresponding switch terminal SW. The switch voltage Vsw in the switch terminal SW[i] will be referred to particularly as a switch voltage Vsw[i]. That is, the switching control circuit 6 generates the switch voltages Vsw[1] to Vsw[n] at the switch terminals SW[1] to SW[n] by individually switching the input voltage Vin by using the output stage circuits MM[1] to MM[n]. In each channel, the coil L[i] and the output capacitor C1 rectify and smooth the switch voltage Vsw[i]. The coils L[1] to L[n] and the output capacitor C1 constitute a rectifying and smoothing circuit that generates the output voltage Vout by rectifying and smoothing the switch voltages Vsw[1] to Vsw[n]. In each channel, the switch terminal SW is connected to the first end of the corresponding coil L. That is, the switch terminal SW[i] is connected to the first end of the coil L[i]. All of the second ends of the coils L[1] to L[n] are commonly connected to the output terminal OUT. The coils L[1] to L[n] have a mutually same inductance value (however, a difference due to an error can occur).

In each channel, the coil current IL flows through a channel (between the drain and the source) of the transistor MH during an on period of the transistor MH, and thereafter the coil current IL flows through a channel of the transistor ML or a parasitic diode of the transistor ML during an off period of the transistor MH.

In each channel, the switching control circuit 6 controls the respective on/off states of the transistors MH and ML by respectively supplying gate signals GH and GL as driving signals to gates of the transistors MH and ML. The transistors MH and ML are turned on and off according to the gate signals GH and GL. The gate signal GH for the transistor MH of the output stage circuit MM[i] will be referred to particularly as a gate signal GH[i], and the gate signal GL for the transistor ML of the output stage circuit MM[i] will be referred to particularly as a gate signal GL[i]. The transistor MH of the output stage circuit MM[i] is set in an on state in a high level period of the gate signal GH[i] and is set in an off state in a low level period of the gate signal GH[i]. Similarly, the transistor ML of the output stage circuit MM[i] is set in an on state in a high level period of the gate signal GL[i] and is set in an off state in a low level period of the gate signal GL[i].

A state in which the transistor MH is set to be on and the transistor ML is set to be off in the output stage circuit MM[i] of an optional channel will be referred to as an output high state. A state in which the transistor MH is set to be off and the transistor ML is set to be on will be referred to as an output low state. A state in which the transistors MH and ML are both set to be off will be referred to as a double off state. In the output stage circuit MM[i] of the optional channel, the transistors MH and ML are not simultaneously set in an on state. In each channel, the transistors MH and ML are basically alternately turned on and off. However, the transistors MH and ML may both be maintained in an off state.

For each of the output stage circuits MM[1] to MM[n], the switching control circuit 6 can perform an operation of switching the output stage circuit MM[i] from the output low state to the output high state and an operation of switching the output stage circuit MM[i] from the output high state to the output low state. In the operation of switching the output stage circuit MM[i] from the output low state to the output high state, the switching control circuit 6 first switches the transistor ML of the output stage circuit MM[i] from on to off by a fall edge of the gate signal GL[i], and thereafter switches the transistor MH of the output stage circuit MM[i] from off to on by generating a rise edge of the gate signal GH[i] after a dead time. In the operation of switching the output stage circuit MM[i] from the output high state to the output low state, the switching control circuit 6 first switches the transistor MH of the output stage circuit MM[i] from on to off by a fall edge of the gate signal GH[i], and thereafter switches the transistor ML of the output stage circuit MM[i] from off to on by generating a rise edge of the gate signal GL[i] after a dead time. The dead time is a minute time inserted in order to reliably avoid simultaneously turning on the transistors MH and ML within the same channel. In the following, the presence of the dead time is ignored unless particularly necessary, and it is considered that, in the output stage circuit MM[i] of the optional channel, the gate signal GL[i] has a low level in the high level period of the gate signal GH[i], and the gate signal GL[i] has a high level in the low level period of the gate signal GH[i].

Incidentally, though not particularly illustrated in the figures, the power supply control device 2 is provided with an internal power supply circuit that generates various kinds of internal power supply voltages on the basis of the input voltage Vin, and each circuit within the power supply control device 2 are driven on the basis of the input voltage Vin or the internal power supply voltages. In each output stage circuit MM, the gate signal GL is a signal with respect to the ground potential, whereas the gate signal GH is a signal with respect to the potential of the switch terminal SW. The gate signal GH at a low level has the potential of the switch terminal SW. The gate signal GH at a high level is higher by a predetermined voltage as viewed from the potential of the switch terminal SW. The predetermined voltage in this case is higher than a gate threshold voltage of the transistor MH. A step-up power supply for generating the gate signal GH can be produced by using a well-known bootstrap circuit (not illustrated). The transistor MH may be configured as a P-channel MOSFET. In that case, the step-up power supply is not necessary.

In addition, as a modification, a diode rectification system may be adopted in the DC/DC converter of each channel. In this case, as the rectifying element, a synchronous rectifier diode that has an anode connected to the ground and a cathode connected to the switch terminal SW is used in place of the transistor ML. In this case, only the transistor MH (output transistor) is turned on and off in the switching control of the output stage circuit MM.

The switching control circuit 6 performs the multi-phase control by using the on-time control system. That is, on the basis of the comparison signal Cout, the switching control circuit 6 sequentially controls the transistors MH of the output stage circuits MM[1] to MM[n] to an on state for the specified on time Ton while shifting the on periods of the transistors MH of the output stage circuits MM[1] to MM[n] from one another. At this time, each time the level of the comparison signal Cout switches from a non-active level to an active level, the switching control circuit 6 switches the transistor MH of one of the channels from off to on and returns the transistor MH to off after the passage of the on time Ton. Here, in order to make the description concrete, suppose that the non-active level of the comparison signal Cout is a low level and that the active level of the comparison signal Cout is a high level (however, a modification is also possible in which the high level is set as the non-active level, and the low level is set as the active level).

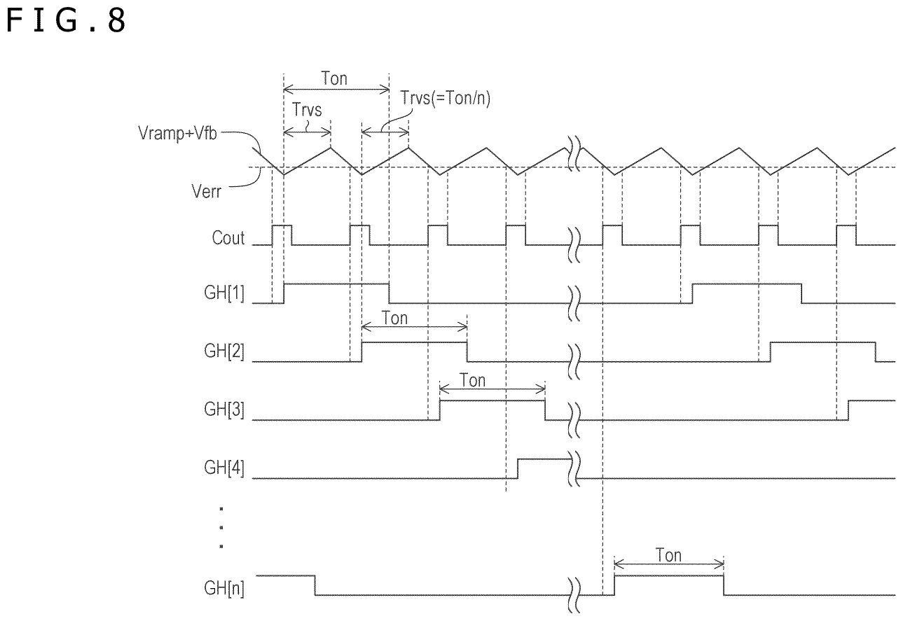

A reference will be made to FIG. 8. FIG. 8 illustrates the waveform of the error voltage Verr as a broken line segment, and illustrates the waveform of a combined voltage (Vramp+Vfb) of the ramp voltage Vramp and the feedback voltage Vfb as a solid line triangular wave. The combined voltage (Vramp+Vfb) is a sum voltage of the ramp voltage Vramp and the feedback voltage Vfb. In addition, FIG. 8 illustrates the waveforms of the comparison signal Cout and gate signals GH[1] to GH[n]. The comparing circuit 5 outputs the comparison signal Cout at a high level in a period in which “Vramp+Vfb<Verr” holds. The comparing circuit 5 outputs the comparison signal Cout at a low level in a period in which “Vramp+Vfb>Verr” holds. The comparison signal Cout in a period in which “Vramp+Vfb=Verr” holds has a high level or a low level.

Then, as illustrated in FIG. 8, the switching control circuit 6 generates a rise edge in the gate signal GH[1] in response to a (1+n×m)th rise edge in the comparison signal Cout, and thereafter generates a fall edge in the gate signal GH[1] when the on time Ton has passed. Hence, the switching control circuit 6 switches the transistor MH of the output stage circuit MM[1] from off to on in response to the (1+n×m)th rise edge in the comparison signal Cout, and returns the transistor MH of the output stage circuit MM[1] to off after the passage of the on time Ton. In other words, the switching control circuit 6 switches the state of the output stage circuit MM[1] from the output low state to the output high state in response to the (1+n×m)th rise edge in the comparison signal Cout, and returns the state of the output stage circuit MM[1] to the output low state after the passage of the on time Ton. Similarly, the switching control circuit 6 generates a rise edge in the gate signal GH[2] in response to a (2+n×m)th rise edge in the comparison signal Cout, and thereafter generates a fall edge in the gate signal GH[2] when the on time Ton has passed. Hence, the switching control circuit 6 switches the transistor MH of the output stage circuit MM[2] from off to on in response to the (2+n×m)th rise edge in the comparison signal Cout, and returns the transistor MH of the output stage circuit MM[2] to off after the passage of the on time Ton. In other words, the switching control circuit 6 switches the state of the output stage circuit MM[2] from the output low state to the output high state in response to the (2+n×m)th rise edge in the comparison signal Cout, and returns the state of the output stage circuit MM[2] to the output low state after the passage of the on time Ton. The same is true for operations in response to other rise edges in the comparison signal Cout.

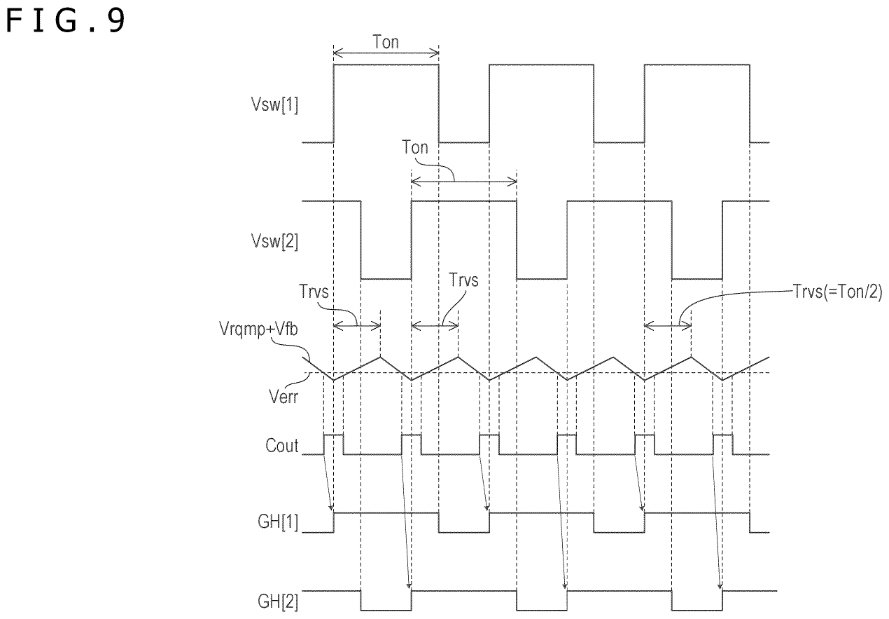

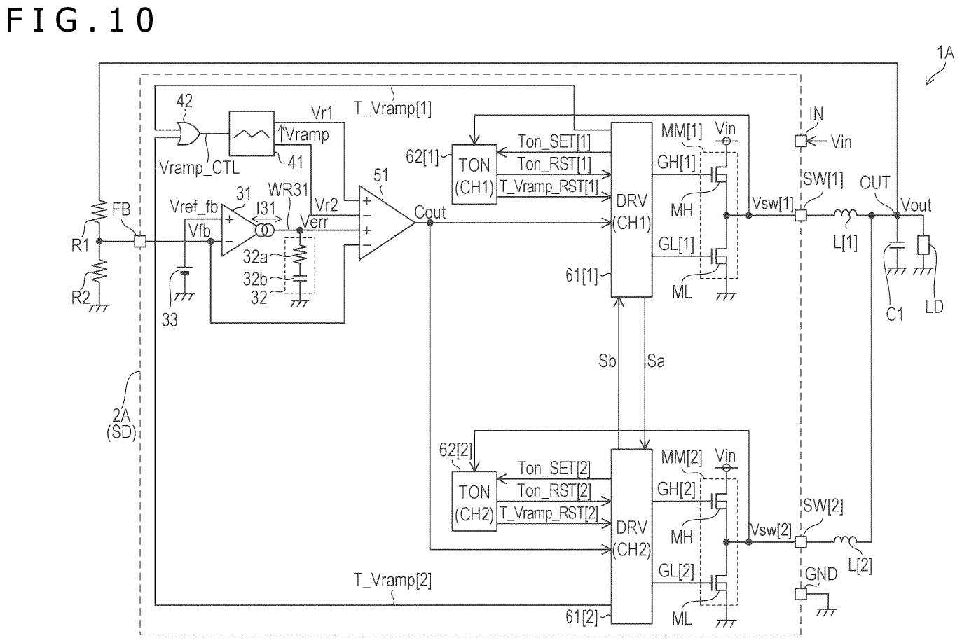

When generalized, the switching control circuit 6 generates a rise edge in a gate signal GH[j] in response to a (j+n×m)th rise edge in the comparison signal Cout, and thereafter generates a fall edge in the gate signal GH[j] when the on time Ton has passed. Hence, the switching control circuit 6 switches the transistor MH of an output stage circuit MM[j] from off to on in response to the (j+n×m)th rise edge in the comparison signal Cout, and returns the transistor MH of the output stage circuit MM[j] to off after the passage of the on time Ton. In other words, the switching control circuit 6 switches the state of the output stage circuit MM[j] from the output low state to the output high state in response to the (j+n×m)th rise edge in the comparison signal Cout, and returns the state of the output stage circuit MM[j] to the output low state after the passage of the on time Ton. j in (j+n×m) denotes an optional natural number of n or less, and m denotes an optional integer of zero or more. Incidentally, FIG. 8 illustrates a state in which a rise edge occurs in the gate signal GH[j] after the passage of a minute time from the timing of the (j+n×m)th rise edge in the comparison signal Cout. The minute time is a delay time occurring within the switching control circuit 6 (the same is true for FIG. 9 to be described later).

Under control of the switching control circuit 6, the ramp voltage generating circuit 4 switches the changing direction of the ramp voltage Vramp from a decreasing direction to a rising direction each time a rise edge occurs in the comparison signal Cout, and in timing in which an inversion trigger time Trvs has passed from the timing of the switching, the ramp voltage generating circuit 4 switches the changing direction of the ramp voltage Vramp from the rising direction to the decreasing direction. Here, “Trvs=Ton/n” holds. That is, the inversion trigger time Trvs coincides with a time obtained by dividing the on time Ton by n (Ton/n). However, the inversion trigger time Trvs may be slightly smaller than the time (Ton/n) (for example, may be smaller than the time (Ton/n) by a predetermined minute time).

In a steady state in which the output voltage Vout is stabilized at the target voltage Vtg (that is, in a state in which “Vout=Vtg”), the on time Ton has a fixed time length corresponding to a ratio between the input voltage Vin and the output voltage Vout. Except for a minute period during a transient response (at least in the steady state), the on times Ton of the first to nth channels are mutually the same, and the on duties of the first to nth channels are also mutually the same. In the following, suppose that unless particularly necessary, the on times Ton of the first to nth channels are mutually the same, and the on duties of the first to nth channels are also mutually the same.

The on time Ton of the ith channel refers to the length of an on period of the transistor MH of the output stage circuit MM[i] (that is, a period from the switching of the transistor MH of the output stage circuit MM[i] from off to on to the returning of the transistor MH of the output stage circuit MM[i] to off) in one cycle of the switching control of the output stage circuit MM[i]. One period of the switching control of the output stage circuit MM[i] is a period from a time point of the switching of the transistor MH in the output stage circuit MM[i] from off to on to a time point immediately before the switching of the transistor MH to on again after the switching of the transistor MH from on to off. Incidentally, the on duty of the ith channel may be referred to as the on duty of the output stage circuit MM[i]. The on duty of the ith channel (on duty of the output stage circuit MM[i]) is a ratio of an on period of the transistor MH of the output stage circuit MM[i] to a sum of the on period of the transistor MH and an on period of the transistor ML of the output stage circuit MM[i].

A steady state in which the load current has a certain current value will be referred to as a reference steady state. In addition, suppose here that the establishment of “Vfb<Vref_fb” brings about an increase in the error voltage Verr, whereas the establishment of “Vfb>Vref_fb” brings about a decrease in the error voltage Verr. When the output voltage Vout becomes lower than the target voltage Vtg due to an increase in the load current with the reference steady state as a starting point, occurrence intervals between rise edges of the comparison signal Cout become smaller than those in the reference steady state through a decrease in the feedback voltage Vfb and an increase in the error voltage Verr. As a result, the on duties of the first to nth channels become larger than the reference steady state, so that the output voltage Vout increases to the target voltage Vtg. Conversely, when the output voltage Vout becomes higher than the target voltage Vtg due to a decrease in the load current with the reference steady state as a starting point, the occurrence intervals between the rise edges of the comparison signal Cout become larger than those in the reference steady state through a rise in the feedback voltage Vfb and a decrease in the error voltage Verr. As a result, the on duties of the first to nth channels become smaller than those in the reference steady state, so that the output voltage Vout decreases to the target voltage Vtg. Such feedback control can provide high responsiveness to variation in the load current.

FIG. 9 illustrates the waveforms of several voltages and signals in a case where “n=2.” FIG. 9 illustrates the waveform of the error voltage Verr as a broken line segment and illustrates the waveform of the combined voltage (Vramp+Vfb) of the ramp voltage Vramp and the feedback voltage Vfb as a solid line triangular wave. In addition, FIG. 9 illustrates the waveforms of the switch voltages Vsw[1] and Vsw[2] in addition to the waveform of the comparison signal Cout and the waveforms of the gate signals GH[1] and GH[2] (dead time is ignored in FIG. 9).

In the case where “n=2,” the switching control circuit 6 generates a rise edge in the gate signal GH[1] in response to an odd-numbered rise edge in the comparison signal Cout, and thereafter generates a fall edge in the gate signal GH[1] when the on time Ton has passed. In other words, the switching control circuit 6 switches the state of the output stage circuit MM[1] from the output low state to the output high state in response to the odd-numbered rise edge in the comparison signal Cout, and returns the state of the output stage circuit MM[1] to the output low state after the passage of the on time Ton. In the case where “n=2,” the switching control circuit 6 generates a rise edge in the gate signal GH[2] in response to an even-numbered rise edge in the comparison signal Cout, and thereafter generates a fall edge in the gate signal GH[2] when the on time Ton has passed. In other words, the switching control circuit 6 switches the state of the output stage circuit MM[2] from the output low state to the output high state in response to the even-numbered rise edge in the comparison signal Cout, and returns the state of the output stage circuit MM[2] to the output low state after the passage of the on time Ton. In the case where “n=2,” the inversion trigger time Trvs coincides with a time (Ton/2) that is ½ of the on time Ton (but may be slightly smaller than ½ of the on time Ton).

FIG. 9 assumes that a sum of the on duty of the first channel and the on duty of the second channel is equal to or more than 100%. As is understood also from FIG. 9, unlike the switching power supply apparatus 920 in FIG. 3, the switching power supply apparatus 1 can perform a desired multi-phase control even when the sum of the on duty of the first channel and the on duty of the second channel is equal to or more than 100%. That is, the switching power supply apparatus 1 in the case where “n=2” can perform a desired multi-phase control even in a case where timing in which two output stage circuits MM are in the output high state at the same time occurs. The switching power supply apparatus 1 in a case where “n≥3” can perform a desired multi-phase control even in a case where timing in which two or more output stage circuits MM are in the output high state at the same time occurs.

### Second Embodiment

A second embodiment of the present disclosure will be described. The second embodiment and third and fourth embodiments to be described later are embodiments based on the first embodiment. With regard to items not particularly described in the second to fourth embodiments, the description of the first embodiment is applied also to the second to fourth embodiments as long as there is no contradiction. However, in construing the description of the second embodiment, the description of the second embodiment may be given priority with regard to items that contradict between the first and second embodiments (the same is true for the third and fourth embodiments to be described later). As long as there is no contradiction, a plurality of optional embodiments among the first to fourth embodiments may be combined with each other.

FIG. 10 illustrates a configuration of a switching apparatus 1A, which is a switching apparatus 1 according to the second embodiment. The switching apparatus 1A includes a power supply control device 2A as the power supply control device 2 (see FIG. 7). In the second embodiment, suppose that “n=2” unless otherwise specified.

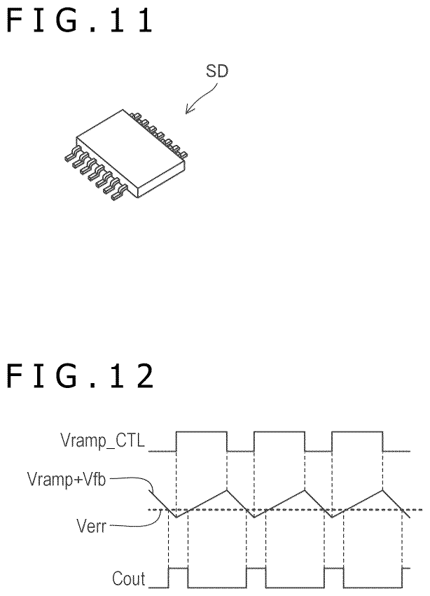

FIG. 11 is an external perspective view of a semiconductor device SD used as the power supply control device 2A. The semiconductor device SD is an electronic part having a semiconductor chip including a semiconductor integrated circuit formed on a semiconductor substrate, a casing (package) housing the semiconductor chip, and a plurality of external terminals exposed from the casing to the outside of the semiconductor device SD. The semiconductor device SD is formed by sealing the semiconductor chip in the casing (package) formed of resin. It is to be noted that the number of the external terminals of the semiconductor device SD illustrated in FIG. 11 and the kind of the casing of the semiconductor device SD are merely illustrative, and these can be designed optionally. FIG. 10 illustrates an input terminal IN, switch terminals SW[1] and SW[2], a ground terminal GND, and a feedback terminal FB as a part of the plurality of external terminals provided to the semiconductor device SD. External terminals other than the above can be provided to the semiconductor device SD.

As illustrated in the first embodiment, the switching apparatus 1A is provided with coils L[1] and L[2], an output capacitor C1, and feedback resistances R1 and R2. Connection relations between the coils L[1] and L[2], the output capacitor C1, the feedback resistances R1 and R2, the switch terminals SW[1] and SW[2], the feedback terminal FB, an output terminal OUT, and a ground are as illustrated in the first embodiment.

The power supply control device 2A includes output stage circuits MM[1] and MM[2], an error amplifier 31, a phase compensating circuit 32, a reference voltage source 33, a ramp circuit 41, an OR circuit 42, a comparator 51, drivers 61[1] and 61[2], and on timer circuits 62[1] and 62[2]. However, the output stage circuits MM[1] and MM[2] can be provided outside the power supply control device 2A (outside the semiconductor device SD). The phase compensating circuit 32 can also be provided outside the power supply control device 2A (outside the semiconductor device SD). The driver 61[1] and the on timer circuit 62[1] are a driver and an on timer circuit for the first channel (CH1). The driver 61[2] and the on timer circuit 62[2] are a driver and an on timer circuit for the second channel (CH2).

The error amplifier 31 and the phase compensating circuit 32 form the error voltage generating circuit 3 in FIG. 7. However, the reference voltage source 33 may also be construed as being included in the constituent elements of the error voltage generating circuit 3. The ramp circuit 41 and the OR circuit 42 form the ramp voltage generating circuit 4 in FIG. 7. The comparator 51 corresponds to the comparing circuit 5 in FIG. 7. The drivers 61[1] and 61[2] and the on timer circuits 62[1] and 62[2] form the switching control circuit 6 in FIG. 7.

The error amplifier 31 is a transconductance amplifier of a current output type. The error amplifier 31 has an inverting input terminal, a non-inverting input terminal, and an output terminal. The inverting input terminal of the error amplifier 31 is connected to the feedback terminal FB and receives a feedback voltage Vfb. The non-inverting input terminal of the error amplifier 31 is supplied with a reference voltage Vref_fb from the reference voltage source 33. The reference voltage Vref_fb is a direct-current voltage having a predetermined positive voltage value. The output terminal of the error amplifier 31 is connected to wiring WR31 (error output wiring).

The error amplifier 31 outputs a current signal I31 corresponding to a difference between the feedback voltage Vfb and the reference voltage Vref_fb from the own output terminal, and thereby generates, in the wiring WR31, a voltage corresponding to the difference between the feedback voltage Vfb and the reference voltage Vref_fb. The voltage applied to the wiring WR31 is the error voltage Verr. A charge produced by the current signal I31 is input to or output from the wiring WR31. Specifically, the error amplifier 31 outputs a current produced by the current signal I31 from the error amplifier 31 to the wiring WR31 so as to raise the potential of the wiring WR31 (that is, so as to raise the error voltage Verr) when the feedback voltage Vfb is lower than the reference voltage Vref_fb, and the error amplifier 31 draws in the current produced by the current signal I31 from the wiring WR31 to the error amplifier 31 so as to decrease the potential of the wiring WR31 (that is, so as to decrease the error voltage Verr) when the feedback voltage Vfb is higher than the reference voltage Vref_fb. As the absolute value of the difference between the feedback voltage Vfb and the reference voltage Vref_fb increases, the magnitude of the current produced by the current signal I31 also increases.

Incidentally, at a time of starting the power supply control device 2A, a soft start voltage that gently rises from 0 V to a voltage exceeding the reference voltage Vref_fb may be generated within the power supply control device 2A. In this case, the error amplifier 31 compares the lower of the reference voltage Vref_fb and the soft start voltage with the feedback voltage Vfb, and generates the current signal I31 on the basis of a result of the comparison. However, consideration will be given here to a state after the soft start voltage becomes higher than the reference voltage Vref_fb. In the following, the presence of the soft start voltage will be ignored.

The phase compensating circuit 32 is provided between the wiring WR31 and the ground. The phase compensating circuit 32 receives the input of the current signal I31 and compensates for the phase of the voltage of the wiring WR31 (phase of the error voltage Verr). The phase compensating circuit 32 has a series circuit of a resistance 32a (phase compensating resistance) and a capacitor 32b (phase compensating capacitor). Specifically, one terminal of the resistance 32a is connected to the wiring WR31, and another terminal of the resistance 32a is connected to the ground via the capacitor 32b. Appropriately setting the resistance value of the resistance 32a and the capacitance value of the capacitor 32b can compensate for the phase of the voltage of the wiring WR31 (phase of the error voltage Verr) and thereby prevent oscillation of an output feedback loop.

The OR circuit 42 is a two-input logical sum circuit. A first input terminal of the OR circuit 42 is supplied with a signal T_Vramp[1] (first ramp command signal) from the driver 61[1]. A second input terminal of the OR circuit 42 is supplied with a signal T_Vramp[2] (second ramp command signal) from the driver 61[2]. The OR circuit 42 outputs a signal Vramp_CTL based on the signals T_Vramp[1] and T_Vramp[2] to the ramp circuit 41. The signals T_Vramp[1], T_Vramp[2], and Vramp_CTL are each a binary signal having a high level or a low level. The OR circuit 42 outputs the signal Vramp_CTL at a high level in a period in which at least one of the signals T_Vramp[1] and T_Vramp[2] has a high level. The OR circuit 42 outputs the signal Vramp_CTL at a low level in a period in which both of the signals T_Vramp[1] and T_Vramp[2] have a low level.

The ramp circuit 41 generates and outputs a ramp voltage Vramp that alternately repeats rising and decreasing according to the signal Vramp_CTL supplied from the OR circuit 42. The ramp circuit 41 monotonically raises the ramp voltage Vramp at a predetermined and fixed raising rate in a high level period of the signal Vramp_CTL, and monotonically decreases the ramp voltage Vramp at a predetermined and fixed decreasing rate in a low level period of the signal Vramp_CTL (see FIG. 12).

Specifically, the ramp voltage generating circuit 41 outputs voltages Vr1 and Vr2. The voltage Vr1 is a sum voltage of the ramp voltage Vramp and the voltage Vr2. The voltage Vr2 has a predetermined positive direct-current voltage value. The voltage Vr1 is a pulsating voltage. The voltage Vr2 corresponds to a direct-current component of the voltage Vr1. That is, “Vramp=Vr1−Vr2.”

The voltage Vr1, the voltage Vr2, the error voltage Verr, and the feedback voltage Vfb are input to the comparator 51 (hence, the ramp voltage Vramp, the error voltage Verr, and the feedback voltage Vfb are input to the comparator 51). The comparator 51 generates and outputs a comparison signal Cout that has a high level or a low level according to a level relation between two voltages based on the ramp voltage Vramp, the error voltage Verr, and the feedback voltage Vfb. Of the two voltages, one is a combined voltage (Vramp+Vfb), and the other is the error voltage Verr. The combined voltage (Vramp+Vfb) is a sum voltage of the ramp voltage Vramp and the feedback voltage Vfb.

FIG. 12 illustrates relations between the signal Vramp_CTL, the error voltage Verr, the combined voltage (Vramp+Vfb), and the comparison signal Cout. The comparator 51 outputs the comparison signal Cout at a high level in a period of establishment of “Vramp+Vfb<Verr,” and outputs the comparison signal Cout at a low level in a period of establishment of “Vramp+Vfb>Verr.” The comparison signal Cout in a period of establishment of “Vramp+Vfb=Verr” has a high level or a low level. As described in the first embodiment, the comparison signal Cout at a low level corresponds to a non-active level, and the comparison signal Cout at a high level corresponds to an active level. The comparison signal Cout from the comparator 51 is input to the drivers 61[1] and 61[2].

The driver 61[1] individually turns on and off transistors MH and ML in the output stage circuit MM[1] by supplying respective gate signals GH[1] and GL[1] to the gate of the transistor MH and the gate of the transistor ML in the output stage circuit MM[1]. In addition, the driver 61[1] outputs a signal Ton_SET[1] to the on timer circuit 62[1] and outputs the signal T_Vramp[1] to the OR circuit 42.

As with the driver 61[1], the driver 61[2] individually turns on and off transistors MH and ML in the output stage circuit MM[2] by respectively supplying gate signals GH[2] and GL[2] to the gate of the transistor MH and the gate of the transistor ML in the output stage circuit MM[2]. In addition, the driver 61[2] outputs a signal Ton_SET[2] to the on timer circuit 62[2] and outputs the signal T_Vramp[2] to the OR circuit 42.

The on timer circuit 62[1] has a first measuring function of measuring the on time Ton of the first channel (that is, a function of measuring whether elapsed time from the switching of the transistor MH of the output stage circuit MM[1] from off to on has reached the specified on time Ton). The on timer circuit 62[1] outputs a signal Ton_RST[1] indicating a result of the measurement of the first measuring function to the driver 61[1]. The on timer circuit 62[1] is connected to the switch terminal SW[1]. The on timer circuit 62[1] can identify the on duty of the output stage circuit MM[1] from an average voltage of a switch voltage Vsw[1] and an input voltage Vin and set the on time Ton of the first channel according to the on duty of the output stage circuit MM[1]. In addition, the on timer circuit 62[1] has a second measuring function of measuring an inversion trigger time Trvs (see FIG. 9), and outputs a signal T_Vramp_RST[1] indicating a result of the measurement of the second measuring function to the driver 61[1]. The second measuring function in the on timer circuit 62[1] is a function of measuring whether the elapsed time from the switching of the transistor MH of the output stage circuit MM[1] from off to on has reached the inversion trigger time Trvs, or in other words, a function of measuring whether a length of a rising period of the ramp voltage Vramp has reached the inversion trigger time Trvs.

As with the on timer circuit 62[1], the on timer circuit 62[2] has a first measuring function of measuring the on time Ton of the second channel (that is, a function of measuring whether an elapsed time from the switching of the transistor MH of the output stage circuit MM[2] from off to on has reached the specified on time Ton). The on timer circuit 62[2] outputs a signal Ton_RST[2] indicating a result of the measurement of the first measuring function to the driver 61[2]. The on timer circuit 62[2] is connected to the switch terminal SW[2]. The on timer circuit 62[2] can identify the on duty of the output stage circuit MM[2] from an average voltage of a switch voltage Vsw[2] and the input voltage Vin and set the on time Ton of the second channel according to the on duty of the output stage circuit MM[2]. In addition, the on timer circuit 62[2] has a second measuring function of measuring the inversion trigger time Trvs (see FIG. 9). The on timer circuit 62[2] outputs a signal T_Vramp_RST[2] indicating a result of the measurement of the second measuring function to the driver 61[2]. The second measuring function in the on timer circuit 62[2] is a function of measuring whether the elapsed time from the switching of the transistor MH of the output stage circuit MM[2] from off to on has reached the inversion trigger time Trvs, or in other words, a function of measuring whether the length of the rising period of the ramp voltage Vramp has reached the inversion trigger time Trvs.

Order control signals Sa and Sb are transmitted and received between the drivers 61[1] and 62[2]. Through the transmission and reception of the order control signals Sa and Sb, the driver 61[1] responds to only odd-numbered rise edges in a group of rise edges in the comparison signal Cout, and the driver 61[2] responds to only even-numbered rise edges in the group of the rise edges in the comparison signal Cout. In the power supply control device 2A illustrated in FIG. 10, the order control signal Sa is output from the driver 61[1] to the driver 61[2], and the order control signal Sb is output from the driver 61[2] to the driver 61[1]. The signals Ton_SET[i], Ton_RST[i], T_Vramp_RST[i], and Sa and Sb are each a binary signal having a high level or a low level.

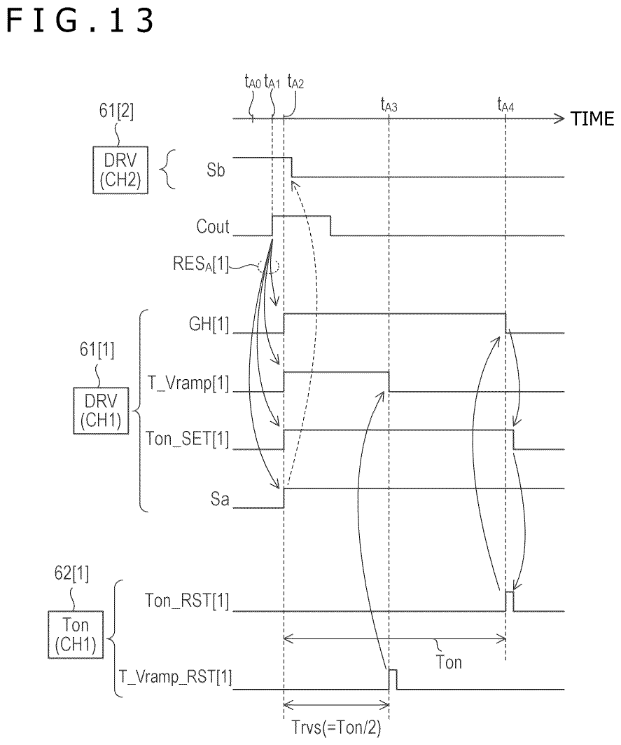

Referring to FIG. 13, a description will be made of an operation of responding to an odd-numbered rise edge in the comparison signal Cout. With the passage of time, times t_{A0}, t_{A1}, t_{A2}, t_{A3}, and t_{A4} occur in this order. Incidentally, in the present specification, an optional time may be construed as a concept having a certain time range. Except for a minute time in a transient state in which the levels of the order control signals Sa and Sb are changed, one of the order control signals Sa and Sb has a high level, and the other has a low level. Each time a rise edge occurs in the comparison signal Cout, the levels of the order control signals Sa and Sb are interchanged. In an initial state of the power supply control device 2A, the order control signal Sb has a high level, and the order control signal Sa has a low level. At time t_{A0}, the order control signal Sb has a high level, and the order control signal Sa has a low level. In addition, at time two, all of the signals Cout, GH[1], T_Vramp[1], Ton_SET[1], Ton_RST[1], and T_Vramp_RST[1] have a low level. At time t_{A1} immediately after time t_{A0}, an odd-numbered rise edge occurs in the comparison signal Cout.

The driver 61[1] performs a response operation RES_{A}[1] when a rise edge occurs in the comparison signal Cout while the order control signal input to the driver 61[1] itself has a high level. In the power supply control device 2A illustrated in FIG. 10, the order control signal input to the driver 61[1] is the order control signal Sb, and the order control signal Sb has a high level at time t_{A1}. Therefore, the response operation RES_{A}[1] is performed at time t_{A2} in response to the rise edge of the comparison signal Cout at time t_{A1}. Time t_{A2} is a time that is later than time t_{A1} by a circuit delay time, but is substantially equal to time t_{A1}.

In the response operation RES_{A}[1], the driver 61[1] switches the state of the output stage circuit MM[1] from the output low state or the double off state to the output high state by generating a rise edge in the gate signal GH[1]. In addition, in the response operation RES_{A}[1], the driver 61[1] generates a rise edge in each of the signals T_Vramp[1] and Ton_SET[1], and generates a rise edge also in the order control signal output by the driver 61[1] itself (signal Sa in this case). Incidentally, the driver 61[1] does not perform the response operation RES_{A}[1] even when a rise edge occurs in the comparison signal Cout while the order control signal input to the driver 61[1] (signal Sb in this case) has a low level.

The on timer circuit 62[1] responds to the rise edge of the signal Ton_SET[1] based on the response operation RES_{A}[1], and measures an elapsed time from the timing of the rise edge of the signal Ton_SET[1] (which elapsed time will hereinafter be referred to as an elapsed time t_{EA}[1]). The elapsed time t_{EA}[1] is an elapsed time from time t_{A2}. The on timer circuit 62[1] generates a rise edge in the signal T_Vramp_RST[1] at time t_{A3} at which the elapsed time t_{EA}[1] reaches the inversion trigger time Trvs. The on timer circuit 62[1] returns the level of the signal T_Vramp_RST[1] to a low level after a predetermined minute time. The driver 61[1] generates a fall edge in the signal T_Vramp[1] in response to the rise edge of the signal T_Vramp_RST[1] at time t_{A3}. A rise in the ramp voltage Vramp on the basis of the signal T_Vramp[1] at a high level therefore ends at time t_{A3}.

In addition, the on timer circuit 62[1] generates a rise edge in the signal Ton_RST[1] at time t_{A4} at which the elapsed time t_{EA}[1] reaches the on time Ton (on time Ton of the first channel). At time t_{A4}, the driver 61[1] generates a fall edge in the gate signal GH[1] in response to the rise edge of the signal Ton_RST[1]. The state of the output stage circuit MM[1] is thereby switched from the output high state to the output low state (to be exact, the state of the output stage circuit MM[1] is switched from the output high state through the double off state to the output low state by generating a rise edge in the gate signal GL[1] after the fall edge of the gate signal GH[1]). In addition, the driver 61[1] generates a fall edge in the signal Ton_SET[1] immediately after generating the fall edge in the gate signal GH[1] at time t_{A4} (or substantially at the same time as the fall edge of the gate signal GH[1]). The on timer circuit 62[1] generates a fall edge in the signal Ton_RST[1] in response to the fall edge of the signal Ton_SET[1]. The on timer circuit 62[1] sets half of the on time Ton of the transistor MH in the output stage circuit MM[1] (or a time slightly shorter than the half) as the inversion trigger time Trvs.

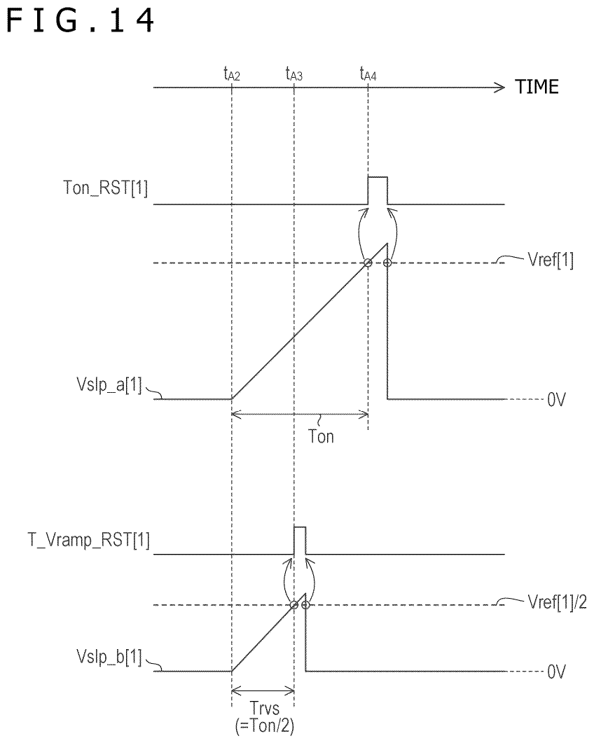

FIG. 14 illustrates the waveforms of signals and voltages within the on timer circuit 62[1]. Slope voltages Vslp_a[1] and Vslp_b[1] are generated within the on timer circuit 62[1], and a reference voltage Vref[1] for determining the on time Ton is generated therewithin. The reference voltage Vref[1] has a positive direct-current voltage value. The on timer circuit 62[1] can adjust the on time Ton of the first channel through adjustment of the reference voltage Vref[1]. The slope voltages Vslp_a[1] and Vslp_b[1] have 0 V in principle. The on timer circuit 62[1] monotonically raises each of the slope voltages Vslp_a[1] and Vslp_b[1] from the occurrence time t_{A2} of the rise edge of the signal Ton_SET[1] (see FIG. 13) at a common and fixed raising rate with 0 V as a starting point.

After time t_{A2}, at time t_{A3} as a time point at which the slope voltage Vslp_b[1] reaches a voltage (Vref[1]/2), the on timer circuit 62[1] generates a rise edge in the signal T_Vramp_RST[1]. The on timer circuit 62[1] sharply decreases the slope voltage Vslp_b[1] to 0 V when a minute time thereafter passes. The signal T_Vramp_RST[1] indicates a level relation between the slope voltage Vslp_b[1] and the voltage (Vref[1]/2). A fall edge occurs in the signal T_Vramp_RST[1] when the slope voltage Vslp_b[1] falls below the voltage (Vref[1]/2) in a process in which the slope voltage Vslp_b[1] decreases to 0 V.

After time t_{A2}, at time t_{A4} as a time point at which the slope voltage Vslp_a[1] reaches the reference voltage Vref[1], the on timer circuit 62[1] generates a rise edge in the signal Ton_RST[1]. The on timer circuit 62[1] sharply decreases the slope voltage Vslp_a[1] to 0 V when a minute time thereafter passes. A trigger for decreasing the slope voltage Vslp_a[1] may be the fall edge of the signal Ton_SET[1]. The signal Ton_RST[1] indicates a level relation between the slope voltage Vslp_a[1] and the reference voltage Vref[1]. A fall edge occurs in the signal Ton_RST[1] when the slope voltage Vslp_a[1] falls below the reference voltage Vref[1] in a process in which the slope voltage Vslp_a[1] decreases to 0 V.

The voltage (Vref[1]/2) is half the reference voltage Vref[1]. In addition, the raising rates of the slope voltages Vslp_a[1] and Vslp_b[1] are equal to each other. Therefore, the inversion trigger time Trvs corresponding to a time difference between times t_{A2} and t_{A3} is half the on time Ton of the first channel. The slope voltage Vslp_a[1] can be generated by a constant current circuit and a capacitor charged by a constant current from the constant current circuit. The same is true for the slope voltage Vslp_b[1].

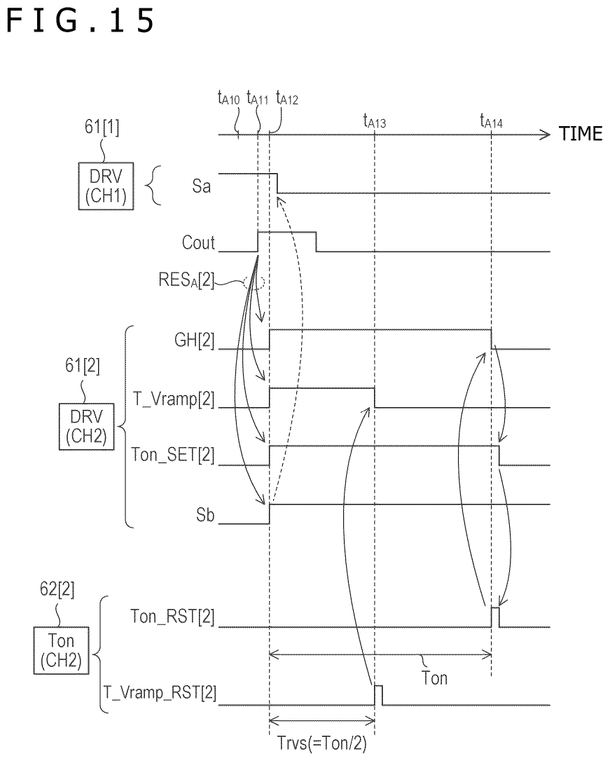

Referring to FIG. 15, a description will be made of an operation of responding to an even-numbered rise edge in the comparison signal Cout. With the passage of time, times t_{A10}, t_{A11}, t_{A12}, t_{A13}, and this occur in this order. At time t_{A10}, the order control signal Sa has a high level, and the order control signal Sb has a low level. In addition, at time t_{A10}, all of the signals Cout, GH[2], T_Vramp[2], Ton_SET[2], Ton_RST[2], and T_Vramp_RST[2] have a low level. At time tau immediately after time t_{A10}, an even-numbered rise edge occurs in the comparison signal Cout.

The driver 61[2] performs a response operation RES_{A}[2] when a rise edge occurs in the comparison signal Cout while the order control signal input to the driver 61[2] itself has a high level. In the power supply control device 2A illustrated in FIG. 10, the order control signal input to the driver 61[2] is the order control signal Sa, and the order control signal Sa has a high level at time tau. Therefore, the response operation RES_{A}[2] is performed at time t_{A12} in response to the rise edge of the comparison signal Cout at time tan. Time t_{A12} is a time that is later than time t_{A11} by a circuit delay time, but is substantially equal to time t_{A11}.

In the response operation RES_{A}[2], the driver 61[2] switches the state of the output stage circuit MM[2] from the output low state or the double off state to the output high state by generating a rise edge in the gate signal GH[2]. In addition, in the response operation RES_{A}[2], the driver 61[2] generates a rise edge in each of the signals T_Vramp[2] and Ton_SET[2], and generates a rise edge also in the order control signal output by the driver 61[2] itself (signal Sb in this case). Incidentally, the driver 61[2] does not perform the response operation RES_{A}[2] even when a rise edge occurs in the comparison signal Cout while the order control signal input to the driver 61[2] (signal Sa in this case) has a low level.

The on timer circuit 62[2] responds to the rise edge of the signal Ton_SET[2] based on the response operation RES_{A}[2], and measures an elapsed time from the timing of the rise edge of the signal Ton_SET[2] (which elapsed time will hereinafter be referred to as an elapsed time t_{EA}[2]). The elapsed time t_{EA}[2] is an elapsed time from time t_{A12}. The on timer circuit 62[2] generates a rise edge in the signal T_Vramp_RST[2] at time t_{A13} at which the elapsed time t_{EA}[2] reaches the inversion trigger time Trvs. The on timer circuit 62[2] returns the level of the signal T_Vramp_RST[2] to a low level after a predetermined minute time. The driver 61[2] generates a fall edge in the signal T_Vramp[2] in response to the rise edge of the signal T_Vramp_RST[2] at time t_{A13}. A rise in the ramp voltage Vramp on the basis of the signal T_Vramp[2] at a high level therefore ends at time t_{A13}.

In addition, the on timer circuit 62[2] generates a rise edge in the signal Ton_RST[2] at time t_{A14} at which the elapsed time t_{EA}[2] reaches the on time Ton (on time Ton of the second channel). At time t_{A14}, the driver 61[2] generates a fall edge in the gate signal GH[2] in response to the rise edge of the signal Ton_RST[2]. The state of the output stage circuit MM[2] is thereby switched from the output high state to the output low state (to be exact, the state of the output stage circuit MM[2] is switched from the output high state through the double off state to the output low state by generating a rise edge in the gate signal GL[2] after the fall edge of the gate signal GH[2]). In addition, the driver 61[2] generates a fall edge in the signal Ton_SET[2] immediately after generating the fall edge in the gate signal GH[2] at time t_{A14} (or substantially at the same time as the fall edge of the gate signal GH[2]). The on timer circuit 62[2] generates a fall edge in the signal Ton_RST[2] in response to the fall edge of the signal Ton_SET[2]. The on timer circuit 62[2] sets half of the on time Ton of the transistor MH in the output stage circuit MM[2] (or a time slightly shorter than the half) as the inversion trigger time Trvs.

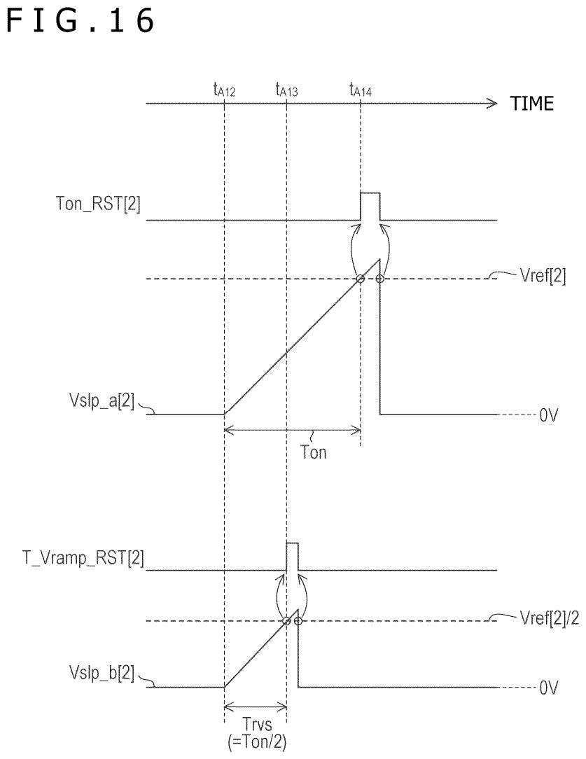

FIG. 16 illustrates the waveforms of signals and voltages within the on timer circuit 62[2]. Slope voltages Vslp_a[2] and Vslp_b[2] are generated within the on timer circuit 62[2], and a reference voltage Vref[2] for determining the on time Ton is generated therewithin. The reference voltage Vref[2] has a positive direct-current voltage value. The on timer circuit 62[2] can adjust the on time Ton of the second channel through adjustment of the reference voltage Vref[2]. The slope voltages Vslp_a[2] and Vslp_b[2] have 0 V in principle. The on timer circuit 62[2] monotonically raises each of the slope voltages Vslp_a[2] and Vslp_b[2] from the occurrence time t_{A12} of the rise edge of the signal Ton_SET[2] (see FIG. 15) at a common and fixed raising rate with 0 V as a starting point.

After time t_{A12}, at time t_{A13} as a time point at which the slope voltage Vslp_b[2] reaches a voltage (Vref[2]/2), the on timer circuit 62[2] generates a rise edge in the signal T_Vramp_RST[2]. The on timer circuit 62[2] sharply decreases the slope voltage Vslp_b[2] to 0 V when a minute time thereafter passes. The signal T_Vramp_RST[2] indicates a level relation between the slope voltage Vslp_b[2] and the voltage (Vref[2]/2). A fall edge occurs in the signal T_Vramp_RST[2] when the slope voltage Vslp_b[2] falls below the voltage (Vref[2]/2) in a process in which the slope voltage Vslp_b[2] decreases to 0 V.

After time t_{A12}, at time t_{A14} as a time point at which the slope voltage Vslp_a[2] reaches the reference voltage Vref[2], the on timer circuit 62[2] generates a rise edge in the signal Ton_RST[2]. The on timer circuit 62[2] sharply decreases the slope voltage Vslp_a[2] to 0 V when a minute time thereafter passes. A trigger for decreasing the slope voltage Vslp_a[2] may be the fall edge of the signal Ton_SET[2]. The signal Ton_RST[2] indicates a level relation between the slope voltage Vslp_a[2] and the reference voltage Vref[2]. A fall edge occurs in the signal Ton_RST[2] when the slope voltage Vslp_a[2] falls below the reference voltage Vref[2] in a process in which the slope voltage Vslp_a[2] decreases to 0 V.

The voltage (Vref[2]/2) is half the reference voltage Vref[2]. In addition, the raising rates of the slope voltages Vslp_a[2] and Vslp_b[2] are equal to each other. Therefore, the inversion trigger time Trvs corresponding to a time difference between times t_{A12} and t_{A13} is half the on time Ton of the second channel. The slope voltage Vslp_a[2] can be generated by a constant current circuit and a capacitor charged by a constant current from the constant current circuit. The same is true for the slope voltage Vslp_b[2]. Incidentally, the raising rates of all of the slope voltages (Vslp_a[1], Vslp_b[1], Vslp_a[2], and Vslp_b[2]) are equal to each other.

It can be considered that “Vref[1]=Vref[2]” except for a minute period during a transient response (at least in the steady state) or that “Vref[1]=Vref[2].” The on time Ton of the first channel and the on time Ton of the second channel are therefore equal to each other. A single reference voltage may be shared as the reference voltages Vref[1] and Vref[2].

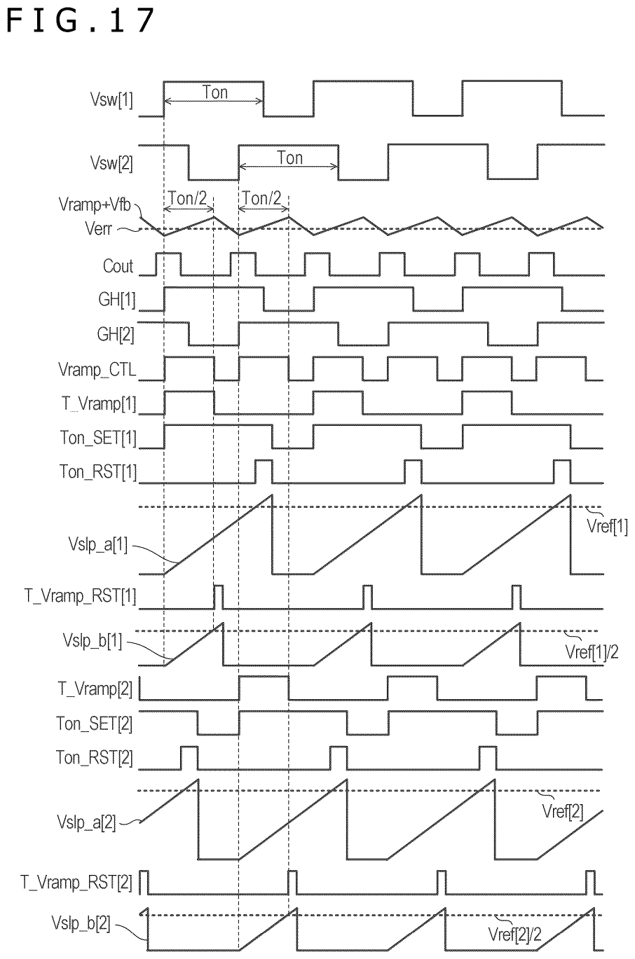

FIG. 17 illustrates a timing diagram of the switching power supply apparatus 1A. Incidentally, FIG. 17 illustrates the switch voltages Vsw[1] and Vsw[2] with the presence of dead times ignored. Illustrated as solid line waveforms in order from an upper side to a lower side of FIG. 17 are the switch voltage Vsw[1], the switch voltage Vsw[2], the combined voltage (Vramp+Vfb), the comparison signal Cout, the gate signal GH[1], the gate signal GH[2], the signal Vramp_CTL, the signal T_Vramp[1], the signal Ton_SET[1], the signal Ton_RST[1], the slope voltage Vslp_a[1], the signal T_Vramp_RST[1], the slope voltage Vslp_b[1], the signal T_Vramp[2], the signal Ton_SET[2], the signal Ton_RST[2], the slope voltage Vslp_a[2], the signal T_Vramp_RST[2], and the slope voltage Vslp_b[2]. FIG. 17 illustrates the error voltage Verr, the reference voltage Vref[1], the voltage (Vref[1]/2), the reference voltage Vref[2], and the voltage (Vref[2]/2) as five broken line waveforms extending in the horizontal direction of the drawing.

FIG. 17 assumes a case where the output voltage Vout is stabilized at the target voltage Vtg in a state in which a sum of the on duty of the first channel and the on duty of the second channel exceeds 100%. The feedback voltage Vfb and the error voltage Verr are held constant in the steady state in which the output voltage Vout is stabilized at the target voltage Vtg. The ramp voltage Vramp changes in the rising direction during a time (Ton/2) from the occurrence of a rise edge in the signal T_Vramp[1] or T_Vramp[2] in response to a rise edge of the comparison signal Cout. The ramp voltage Vramp otherwise changes in the decreasing direction.

When the output voltage Vout becomes lower than the target voltage Vtg due to an increase in the load current with the state illustrated in FIG. 17 as a starting point, occurrence intervals between rise edges of the comparison signal Cout become smaller than those in the state illustrated in FIG. 17 through a decrease in the feedback voltage Vfb and an increase in the error voltage Verr. As a result, the on duties of the first and second channels become larger than those in the state illustrated in FIG. 17, so that the output voltage Vout increases to the target voltage Vtg. Conversely, when the output voltage Vout becomes higher than the target voltage Vtg due to a decrease in the load current with the state illustrated in FIG. 17 as a starting point, the occurrence intervals between the rise edges of the comparison signal Cout become larger than those in the state illustrated in FIG. 17 through a rise in the feedback voltage Vfb and a decrease in the error voltage Verr. As a result, the on duties of the first and second channels become smaller than those in the state illustrated in FIG. 17, so that the output voltage Vout decreases to the target voltage Vtg. Such feedback control can provide high responsiveness to variation in the load current.

The signal T_Vramp[i] functions as a ramp command signal that specifies the changing direction of the ramp voltage Vramp. The state of the signal T_Vramp[i] is one of a negated state and an asserted state. The signal T_Vramp[i] in an asserted state specifies that the changing direction of the ramp voltage Vramp is to be set as the rising direction. The ramp circuit 41 outputs the ramp voltage Vramp following the contents specified by the ramp command signal (T_Vramp[1] and T_Vramp[2]). The signal T_Vramp[i] in a negated state does not specify that the changing direction of the ramp voltage Vramp is to be set as the rising direction. In the present embodiment, the negated state is associated with the signal T_Vramp[i] at a low level, and the asserted state is associated with the signal T_Vramp[i] at a high level (however, the association relations thereof can be reversed).

The switching control circuit (61[1], 62[1], 61[2], and 62[2]) according to the second embodiment supplies the first and second ramp command signals (T_Vramp[1] and T_Vramp[2]) to the ramp voltage generating circuit (41 and 42) (see FIG. 10). The switching control circuit (61[1], 62[1], 61[2], and 62[2]) switches the ith ramp command signal (T_Vramp[i]) from a negated state (low level) to an asserted state (high level) when switching the transistor MH of the ith channel from off to on in response to the switching of the level of the comparison signal Cout from a non-active level (low level) to an active level (high level). The switching control circuit switches the ith ramp command signal (T_Vramp[i]) from the asserted state to a negated state when the inversion trigger time Trvs thereafter passes (see FIG. 13 and FIG. 15; i is a natural number of n or less). The ramp voltage generating circuit (41 and 42) sets the changing direction of the ramp voltage Vramp to a first direction in a period in which the first and second ramp command signals are each in a negated state, and sets the changing direction of the ramp voltage Vramp to a second direction in a period in which one of the first and second ramp command signals is in an asserted state. In the present embodiment, the first direction is the decreasing direction, and the second direction is the rising direction.

The second embodiment includes the following examples EX2_1 and EX2_2.

### Example EX2_1

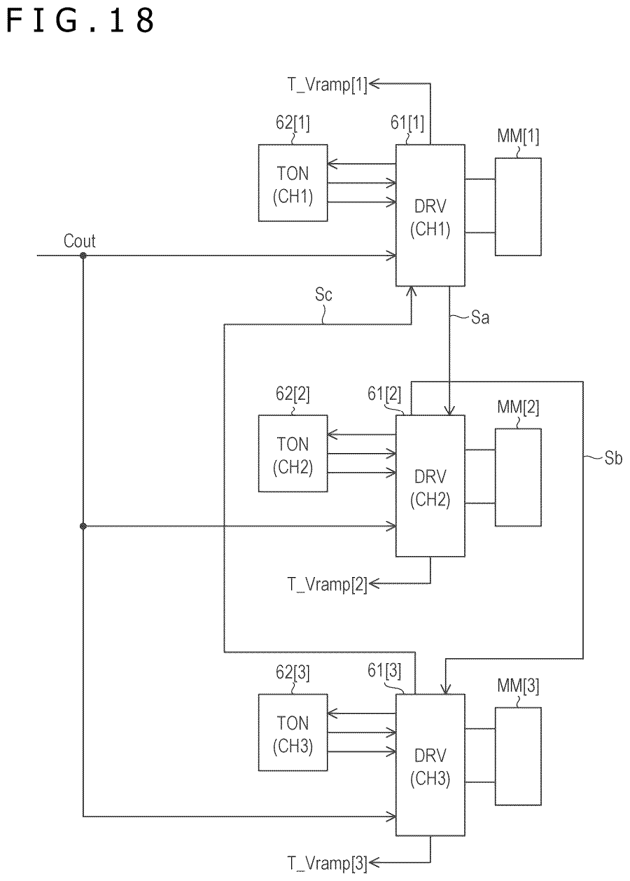

The example EX2_1 will be described. FIG. 10 illustrates the switching power supply apparatus 1 in a case where “n=2” as the switching power supply apparatus 1A. However, as described above, the value of n (number of channels) is optional as long as the value of n is 2 or more. For example, in a case where “n=3” in the second embodiment, a circuit group for a third channel is added to the switching apparatus 1A illustrated in FIG. 10. The circuit group for the third channel includes a coil L[3] as well as a driver 61[3], an on timer circuit 62[3], and an output stage circuit MM[3] added to the power supply control device 2A in FIG. 10 (see FIG. 18).

FIG. 18 illustrates a partial configuration of the power supply control device 2 (2A) in the case where “n=3.” Operation of the driver 61[3] and the on timer circuit 62[3] is similar to the operation of the driver 61[1] and the on timer circuit 62[1]. It suffices to read the symbol “[i]” for the symbol “[1]” in the above description made for the operation of the driver 61[1] and the on timer circuit 62[1] as well as the symbol “[1]” associated with the input and output signals of the driver 61[1] and the on timer circuit 62[1], and regard the variable i as 1, 2, or 3.

However, in the case where “n=3,” order control signals Sa, Sb, and Sc are transmitted and received between the drivers 61[1] to 61[3]. As with the order control signals Sa and Sb, the order control signal Sc is a binary signal having a high level or a low level. In the case where “n=3,” through the transmission and reception of the order control signals Sa to Sc, the driver 61[1] performs a response operation RES_{A}[1] in response to only (1+3×m)th rise edges in the group of the rise edges in the comparison signal Cout (see FIG. 13), the driver 61[2] performs a response operation RES_{A}[2] in response to only (2+3×m)th rise edges within the group of the rise edges in the comparison signal Cout (see FIG. 15), and the driver 61[3] performs a response operation RES_{A}[3] in response to only (3+3×m)th rise edges in the group of the rise edges in the comparison signal Cout. m denotes an optional integer of 0 or more. In the case where “n=3,” the order control signal Sa is supplied from the driver 61[1] to the driver 61[2], the order control signal Sb is supplied from the driver 61[2] to the driver 61[3], and the order control signal Sc is supplied from the driver 61[3] to the driver 61[1].

Except for a minute time in a transient state in which the levels of the order control signals Sa to Sc are changed, only one of the order control signals Sa to Sc has a high level, and the other two order control signals have a low level. Then, each time a rise edge occurs in the comparison signal Cout, the order control signal having a high level is changed in order among the order control signals Sa to Sc. In an initial state of the power supply control device 2 (2A) in the case where “n=3,” the order control signal Sc has a high level, and the order control signals Sa and Sb have a low level.

The driver 61[1] performs a response operation RES_{A}[1] when a rise edge occurs in the comparison signal Cout while the order control signal input to the driver 61[1] itself (signal Sc in the configuration of FIG. 18) has a high level. The driver 61[2] performs a response operation RES_{A}[2] when a rise edge occurs in the comparison signal Cout while the order control signal input to the driver 61[2] itself (signal Sa in the configuration of FIG. 18) has a high level. The driver 61[3] performs a response operation RES_{A}[3] when a rise edge occurs in the comparison signal Cout while the order control signal input to the driver 61[3] itself (signal Sb in the configuration of FIG. 18) has a high level. An operation obtained by reading the symbol “[3]” for the symbol “[1]” in the above description made for the response operation RES_{A}[1] corresponds to the response operation RES_{A}[3].

Hence, in the response operation RES_{A}[3], the driver 61[3] generates a rise edge in the signal T_Vramp[3] that is output by the driver 61[3] itself. Thereafter, when the inversion trigger time Trvs has passed, the driver 61[3] generates a fall edge in the signal T_Vramp[3] on the basis of output of the on timer circuit 62[3]. In the case where “n=3,” it suffices to input a logical sum signal of the signals T_Vramp[1] to T_Vramp[3] as the signal Vramp_CTL to the ramp circuit 41, and it suffices for the ramp circuit 41 to set the changing direction of the ramp voltage Vramp to the rising direction in a period in which one of the signals T_Vramp[1] to T_Vramp[3] has a high level and set the changing direction of the ramp voltage Vramp to the decreasing direction in a period in which the signals T_Vramp[1] to T_Vramp[3] all have a low level.

In the case where “n=3,” the drivers 61[1] to 61[3] and the on timer circuits 62[1] to 62[3] form the switching control circuit 6 in FIG. 7. The same is true for a case where “n≥4.”

When generalized by supposing that n denotes an optional integer of 2 or more, the switching control circuit 6 and the ramp voltage generating circuit 4 according to the second embodiment (see FIG. 7) can be said to operate as follows. That is, each time the level of the comparison signal Cout switches from a non-active level (low level) to an active level (high level), the switching control circuit 6 according to the second embodiment switches one of the transistors MH of the first to nth channels from off to on, maintains the transistor MH in an on state for the specified on time Ton, and then returns the transistor MH to off. At this time, the switching control circuit 6 changes the transistor MH switched from off to on in order among the transistors MH of the first to nth channels. That is, supposing that the active level is a high level, the switching control circuit 6 switches the transistor MH of a jth channel from off to on in response to a (j+n×m)th rise edge in the comparison signal Cout (j denotes an optional natural number of n or less, and m denotes an optional integer of 0 or more). The switching control circuit 6 including drivers 61[1] to 61[n] and on timer circuits 62[1] to 62[n] supplies signals T_Vramp[1] to T_Vramp[n] as first to nth ramp command signals to the ramp voltage generating circuit 4 (41 and 42), switches the ith ramp command signal (T_Vramp[i]) from a negated state (low level) to an asserted state (high level) when switching the transistor MH of the ith channel from off to on in response to switching of the level of the comparison signal Cout from a non-active level (low level) to an active level (high level), and then switches the ith ramp command signal from the asserted state to a negated state when the inversion trigger time Trvs has passed (see FIG. 13 and FIG. 15). The inversion trigger time Trvs is set to be equal to or less than the time (Ton/n). The ramp voltage generating circuit 4 (41 and 42) according to the second embodiment sets the changing direction of the ramp voltage Vramp to the first direction (decreasing direction) in a period in which the first to nth ramp command signals (T_Vramp[1] to T_Vramp[n]) are all in a negated state, and sets the changing direction of the ramp voltage Vramp to the second direction (rising direction) in a period in which one of the first to nth ramp command signals is in an asserted state.

Incidentally, the signal Vramp_CTL may be construed as a ramp command signal (single ramp command signal). The switching control circuit 6 switches the signal Vramp_CTL from a negated state (low level) to an asserted state (high level) when switching the transistor MH of an optional channel from off to on in response to switching of the level of the comparison signal Cout from a non-active level (low level) to an active level (high level), and then switches the signal Vramp_CTL from the asserted state to a negated state when the inversion trigger time Trvs has passed.

### Example EX2_2

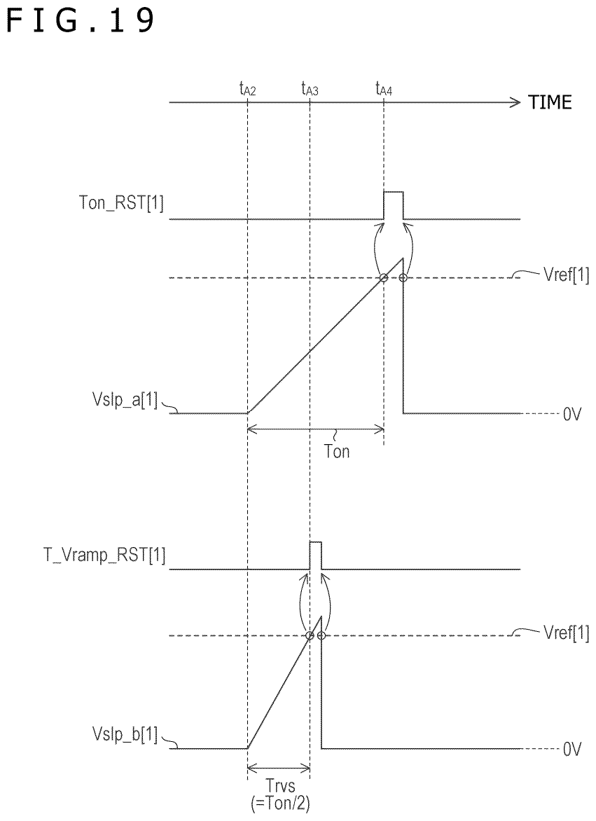

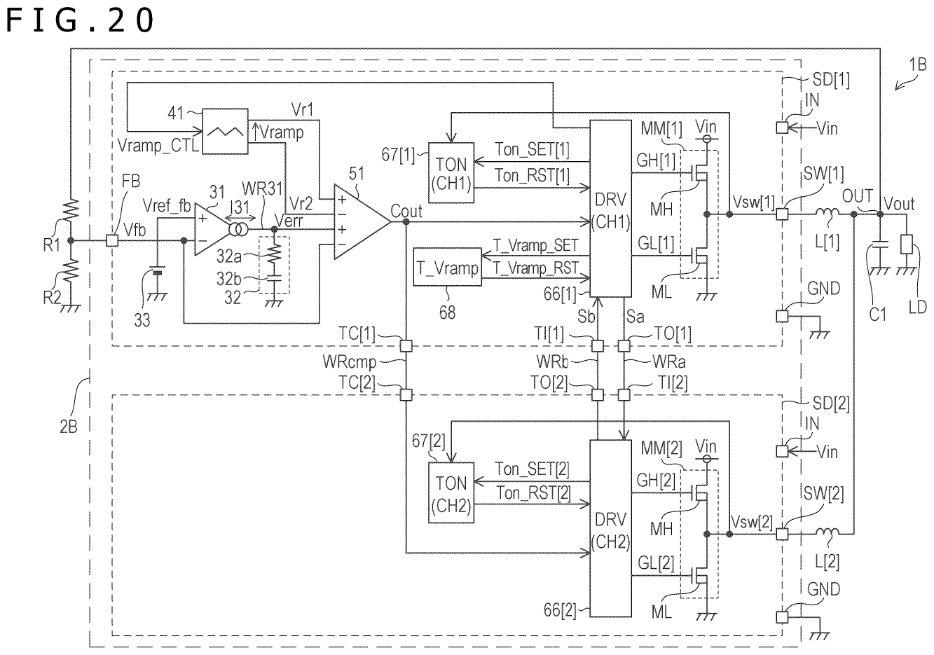

The example EX2_2 will be described. A method of measuring the inversion trigger time Trvs is optional. For example, as illustrated in FIG. 19, after the raising rate of the slope voltage Vslp_b[1] is set to be twice the raising rate of the slope voltage Vslp_a[1], the slope voltage Vslp_b[1] starts to be raised from 0 V from time t_{A2}. At time t_{A3} as a time point at which the slope voltage Vslp_b[1] reaches the reference voltage Vref[1], the on timer circuit 62[1] may generate a rise edge in the signal T_Vramp_RST[1]. A Time that is ½ of the on time Ton of the first channel can be thereby set as the inversion trigger time Trvs. The same is true for the second channel.

When generalized by supposing that n denotes an optional integer of 2 or more, for an optional natural number i of n or less (see FIG. 13 and FIG. 14), it suffices for the on timer circuit 62[i] to operate as follows. That is, it suffices for the on timer circuit 62[i] to set the raising rates of slope voltages Vslp_a[i] and Vslp_b[i] to be the same, thereafter start to raise the slope voltages Vslp_a[i] and Vslp_b[i] from 0 V from timing of a rise edge in the signal Ton_SET[i], set, as the on time Ton, a time from the raising start timing to the reaching of a reference voltage Vref[i] by the slope voltage Vslp_a[i], and set, as the inversion trigger time Trvs, a time from the raising start timing to the reaching of a voltage (Vref[i]/n) by the slope voltage Vslp_b[i] or a time from the raising start timing to the reaching of a voltage lower by a minute voltage than the voltage (Vref[i]/n) by the slope voltage Vslp_b[i].

Alternatively, for the optional natural number i of n or less (see FIG. 13 and FIG. 19), it suffices for the on timer circuit 62[i] to set the raising rate of the slope voltage Vslp_b[i] to be n times the raising rate of the slope voltage Vslp_a[i], thereafter start to raise the slope voltages Vslp_a[i] and Vslp_b[i] from 0 V from timing of a rise edge in the signal Ton_SET[i], set, as the on time Ton, a time from the raising start timing to the reaching of the reference voltage Vref[i] by the slope voltage Vslp_a[i], and set, as the inversion trigger time Trvs, a time from the raising start timing to the reaching of the reference voltage Vref[i] by the slope voltage Vslp_b[i] or a time from the raising start timing to the reaching of a voltage lower by a minute voltage than the reference voltage Vref[i] by the slope voltage Vslp_b[i].

### Third Embodiment

A third embodiment of the present disclosure will be described. FIG. 20 illustrates a configuration of a switching apparatus 1B, which is a switching apparatus 1 according to the third embodiment. The switching apparatus 1B includes a power supply control device 2B as the power supply control device 2 (see FIG. 7). In the third embodiment, suppose that “n=2” unless otherwise specified. The power supply control device 2B includes semiconductor devices SD[1] and SD[2] as two electronic parts separated from each other.

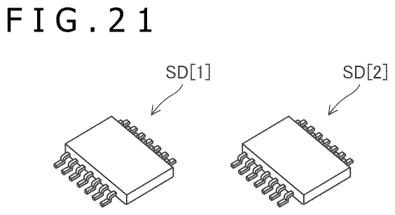

FIG. 21 is an external perspective view of the semiconductor devices SD[1] and SD[2]. The semiconductor device SD[i] is an electronic part having a semiconductor chip including a semiconductor integrated circuit formed on a semiconductor substrate, a casing (package) housing the semiconductor chip, and a plurality of external terminals exposed from the casing to the outside of the semiconductor device SD[i]. The semiconductor device SD[i] is formed by sealing the semiconductor chip in the casing (package) formed of resin. Incidentally, the number of the external terminals of the semiconductor device SD[i] illustrated in FIG. 21 and the kind of the casing of the semiconductor device SD[i] are merely illustrative, and these can be designed optionally. The plurality of external terminals provided to the semiconductor device SD[1] include an input terminal IN, a switch terminal SW[1], a ground terminal GND, and a feedback terminal FB, and include cooperation terminals TI[1], TO[1], and TC[1]. External terminals other than the above can be provided to the semiconductor device SD[1]. The plurality of external terminals provided to the semiconductor device SD[2] include an input terminal IN, a switch terminal SW[2], and a ground terminal GND, and include cooperation terminals TI[2], TO[2], and TC[2]. External terminals other than the above can be provided to the semiconductor device SD[2].

As illustrated in the first embodiment, the switching apparatus 1B is provided with coils L[1] and L[2], an output capacitor C1, and feedback resistances R1 and R2. Connection relations between the coils L[1] and L[2], the output capacitor C1, the feedback resistances R1 and R2, the switch terminals SW[1] and SW[2], the feedback terminal FB, an output terminal OUT, and a ground are as illustrated in the first embodiment.

The respective input terminals IN of the semiconductor devices SD[1] and SD[2] are supplied with a common input voltage Vin. The respective ground terminals GND of the semiconductor devices SD[1] and SD[2] are connected to the ground. Pieces of wiring WRa, WRb, and WRcmp are external wiring provided outside the semiconductor devices SD[1] and SD[2]. The cooperation terminal TO[1] is connected to the cooperation terminal TI[2] through the external wiring WRa. The cooperation terminal TI[1] is connected to the cooperation terminal TO[2] through the external wiring WRb. The cooperation terminal TC[1] is connected to the cooperation terminal TC[2] through the external wiring WRcmp.

The semiconductor device SD[1] includes an output stage circuit MM[1], an error amplifier 31, a phase compensating circuit 32, a reference voltage source 33, a ramp circuit 41, a comparator 51, a driver 66[1], an on timer circuit 67[1], and a ramp timer circuit 68. However, the output stage circuit MM[1] can be provided outside the semiconductor device SD[1]. The phase compensating circuit 32 can also be provided outside the semiconductor device SD[1]. The semiconductor device SD[2] includes an output stage circuit MM[2], a driver 66[2], and an on timer circuit 67[2]. However, the output stage circuit MM[2] can be provided outside the semiconductor device SD[2]. The driver 66[1] and the on timer circuit 67[1] are a driver and an on timer circuit for the first channel (CH1). The driver 66[2] and the on timer circuit 67[2] are a driver and an on timer circuit for the second channel (CH2).

The error amplifier 31 and the phase compensating circuit 32 form the error voltage generating circuit 3 in FIG. 7. However, the reference voltage source 33 may also be construed as being included in the constituent elements of the error voltage generating circuit 3. The ramp circuit 41 forms the ramp voltage generating circuit 4 in FIG. 7. The comparator 51 corresponds to the comparing circuit 5 in FIG. 7. The drivers 66[1] and 66[2], the on timer circuits 67[1] and 67[2], and the ramp timer circuit 68 form the switching control circuit 6 in FIG. 7.

The semiconductor device SD[1] functions as a controller side device in multi-phase control. The semiconductor device SD[2] functions as a target side device in the multi-phase control. A first or second configuring method can be adopted as a configuring method for the semiconductor devices SD[1] and SD[2]. In the first configuring method, the semiconductor devices SD[1] and SD[2] are mutually different kinds of semiconductor devices having mutually different configurations. In the second configuring method, two semiconductor devices having a mutually same configuration are used as the semiconductor devices SD[1] and SD[2]. In the second configuring method, each semiconductor device is provided with the constituent elements of the semiconductor device SD[1] in FIG. 20, but in a semiconductor device of the two semiconductor devices, which is on a side functioning as the semiconductor device SD[2], a circuit group including the error amplifier 31, the phase compensating circuit 32, the reference voltage source 33, the ramp circuit 41, the comparator 51, and the ramp timer circuit 68 stops operating. In the second configuring method, of the two semiconductor devices, a semiconductor device that is supplied with a first setting signal functions as the semiconductor device SD[1], and a semiconductor device that is supplied with a second setting signal functions as the semiconductor device SD[2]. For example, each semiconductor device according to the second configuring method can be provided with a setting terminal in advance, and of the two semiconductor devices, a semiconductor device having a setting terminal that is supplied with the first setting signal (for example, a setting signal having a high level) can be made to function as the semiconductor device SD[1], and a semiconductor device having a setting terminal that is supplied with the second setting signal (for example, a setting signal having a low level) can be made to function as the semiconductor device SD[2]. A microcomputer provided outside the two semiconductor devices or the like may supply the first setting signal to one of the two semiconductor devices and supply the second setting signal to the other.

A configuration and operation of the error amplifier 31, the phase compensating circuit 32, the reference voltage source 33, the ramp circuit 41, and the comparator 51 in the power supply control device 2B are similar to the configuration and operation of the error amplifier 31, the phase compensating circuit 32, the reference voltage source 33, the ramp circuit 41, and the comparator 51 illustrated in the second embodiment. Hence, also in the power supply control device 2B, the comparison signal Cout is obtained by the signal relations illustrated in FIG. 12. However, in the power supply control device 2B, the signal Vramp_CTL is supplied from the driver 66[1] to the ramp circuit 41. In addition, in the power supply control device 2B, the comparison signal Cout output from the comparator 51 is supplied to the drivers 66[1] and 66[2].

The driver 66[1] individually turns on and off transistors MH and ML in the output stage circuit MM[1] by supplying respective gate signals GH[1] and GL[1] to the gate of the transistor MH and the gate of the transistor ML in the output stage circuit MM[1]. In addition, the driver 66[1] outputs a signal Ton_SET[1] to the on timer circuit 67[1], outputs a signal T_Vramp_SET to the ramp timer circuit 68, and outputs a signal Vramp_CTL to the ramp circuit 41.

As with the driver 66[1], the driver 66[2] individually turns on and off transistors MH and ML in the output stage circuit MM[2] by supplying respective gate signals GH[2] and GL[2] to the gate of the transistor MH and the gate of the transistor ML in the output stage circuit MM[2]. In addition, the driver 66[2] outputs a signal Ton_SET[2] to the on timer circuit 67[2].

The on timer circuit 67[1] has a first measuring function of measuring the on time Ton of the first channel (that is, a function of measuring whether an elapsed time from the switching of the transistor MH of the output stage circuit MM[1] from off to on has reached the specified on time Ton). The on timer circuit 67[1] outputs a signal Ton_RST[1] indicating a result of the measurement of the first measuring function to the driver 66[1]. The on timer circuit 67[1] is connected to the switch terminal SW[1]. The on timer circuit 67[1] can identify the on duty of the output stage circuit MM[1] from an average voltage of a switch voltage Vsw[1] and the input voltage Vin, and set the on time Ton of the first channel according to the on duty of the output stage circuit MM[1].

As with the on timer circuit 67[1], the on timer circuit 67[2] has a first measuring function of measuring the on time Ton of the second channel (that is, a function of measuring whether an elapsed time from the switching of the transistor MH of the output stage circuit MM[2] from off to on has reached the specified on time Ton). The on timer circuit 67[2] outputs a signal Ton_RST[2] indicating a result of the measurement of the first measuring function to the driver 66[2]. The on timer circuit 67[2] is connected to the switch terminal SW[2]. The on timer circuit 67[2] can identify the on duty of the output stage circuit MM[2] from an average voltage of a switch voltage Vsw[2] and the input voltage Vin and set the on time Ton of the second channel according to the on duty of the output stage circuit MM[2].

The ramp timer circuit 68 has a second measuring function of measuring the inversion trigger time Trvs (see FIG. 9). The ramp timer circuit 68 outputs a signal T_Vramp_RST indicating a result of the measurement of the second measuring function to the driver 66[1]. The second measuring function in the ramp timer circuit 68 is a function of measuring whether the elapsed time from the switching of the transistor MH of the output stage circuit MM[1] or MM[2] from off to on has reached the inversion trigger time Trvs, or in other words, a function of measuring whether the length of the rising period of the ramp voltage Vramp has reached the inversion trigger time Trvs.

Order control signals Sa and Sb are transmitted and received between the drivers 66[1] and 66[2]. Within the semiconductor device SD[1], the driver 66[1] is connected to the cooperation terminals TO[1] and TI[1]. Within the semiconductor device SD[2], the driver 66[2] is connected to the cooperation terminals TO[2] and TI[2]. The driver 66[1] outputs the order control signal Sa to the cooperation terminal TO[1]. Hence, the order control signal Sa from the driver 66[1] is input to the driver 66[2] via the cooperation terminal TO[1], the external wiring WRa, and the cooperation terminal TI[2]. The driver 66[2] outputs the order control signal Sb to the cooperation terminal TO[2]. Hence, the order control signal Sb from the driver 66[2] is input to the driver 66[1] via the cooperation terminal TO[2], the external wiring WRb, and the cooperation terminal TI[1]. The signals Ton_SET[i], Ton_RST[i], T_Vramp_SET, T_Vramp_RST, Vramp_CTL, and Sa and Sb are each a binary signal having a high level or a low level.

In addition, in the power supply control device 2B, the comparison signal Cout output from the comparator 51 is supplied to the driver 66[1] within the semiconductor device SD[1], and is supplied to the cooperation terminal TC[1]. The cooperation terminal TC[1] is connected to the cooperation terminal TC[2] by the external wiring WRcmp. The comparison signal Cout output from the comparator 51 is therefore supplied also to the driver 66[2] via the cooperation terminal TC[1], the external wiring WRcmp, and the cooperation terminal TC[2].

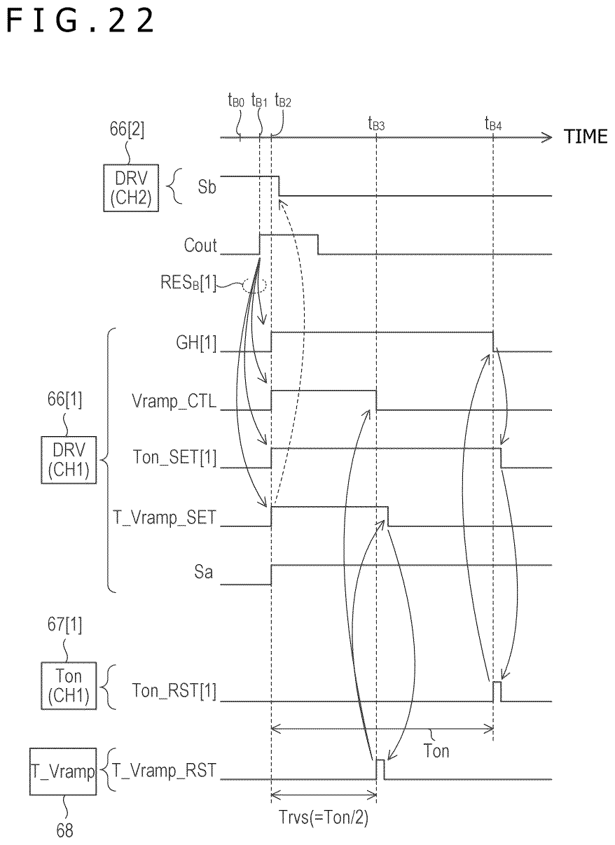

Referring to FIG. 22, a description will be made of an operation of responding to an odd-numbered rise edge in the comparison signal Cout. With the passage of time, times t_{B0}, t_{B1}, t_{B2}, t_{B3}, and t_{B4} occur in this order. Except for a minute time in a transient state in which the levels of the order control signals Sa and Sb are changed, one of the order control signals Sa and Sb has a high level, and the other has a low level. Each time a rise edge occurs in the comparison signal Cout, the levels of the order control signals Sa and Sb are interchanged. In an initial state of the power supply control device 2B, the order control signal Sb has a high level, and the order control signal Sa has a low level. At time t_{B0}, the order control signal Sb has a high level, and the order control signal Sa has a low level. In addition, at time t_{B0}, the signals Cout, GH[1], Vramp_CTL, Ton_SET[1], T_VRAMP_SET, Ton_RST[1], and T_Vramp_RST all have a low level. At time t_{B1} immediately after time t_{B0}, an odd-numbered rise edge occurs in the comparison signal Cout.

The driver 66[1] performs a response operation RES_{B}[1] when a rise edge occurs in the comparison signal Cout while the order control signal input to the driver 66[1] itself has a high level. In the power supply control device 2B illustrated in FIG. 20, the order control signal input to the driver 66[1] is the order control signal Sb, and the order control signal Sb has a high level at time t_{B1}. Therefore, the response operation RES_{B}[1] is performed at time t_{B2} in response to the rise edge of the comparison signal Cout at time t_{B1}. Time t_{B2} is a time later than time t_{B1} by a circuit delay time, but is substantially equal to time t_{B1}.

In the response operation RES_{B}[1], the driver 66[1] switches the state of the output stage circuit MM[1] from the output low state or the double off state to the output high state by generating a rise edge in the gate signal GH[1]. In addition, in the response operation RES_{B}[1], the driver 66[1] generates a rise edge in each of the signals Vramp_CTL, Ton_SET[1], and T_Vramp_SET, and generates a rise edge also in the order control signal output by the driver 66[1] itself (signal Sa in this case). Incidentally, the driver 66[1] does not perform the response operation RES_{B}[1] even when a rise edge occurs in the comparison signal Cout while the order control signal input to the driver 66[1] (signal Sb in this case) has a low level.

The on timer circuit 67[1] responds to the rise edge of the signal Ton_SET[1] based on the response operation RES_{B}[1], and measures elapsed time from the timing of the rise edge of the signal Ton_SET[1]. Meanwhile, the ramp timer circuit 68 responds to the rise edge of the signal T_Vramp_SET based on the response operation RES_{B}[1], and measures an elapsed time from the timing of the rise edge of the signal T_Vramp_SET. The respective rise edges of the signals Ton_SET[1] and T_Vramp_SET based on the response operation RES_{B}[1] occur at time t_{B2}. Hence, the on timer circuit 67[1] and the ramp timer circuit 68 both measure an elapsed time from time t_{B2} (which elapsed time will hereinafter be referred to as an elapsed time t_{EB}[1]).

The ramp timer circuit 68 generates a rise edge in the signal T_Vramp_RST at time t_{B3} at which the elapsed time t_{EB}[1] reaches the inversion trigger time Trvs. The driver 66[1] generates a fall edge in the signal Vramp_CTL in response to the rise edge of the signal T_Vramp_RST at time t_{B3}. A rise in the ramp voltage Vramp on the basis of the signal Vramp_CTL at a high level from time to: therefore ends at time t_{B3}. In addition, when the driver 66[1] receives the rise edge of the signal T_Vramp_RST at time t_{B3}, the driver 66[1] generates a fall edge in the signal T_Vramp_SET after a predetermined minute time. In response to the fall edge of the signal T_Vramp_SET, the ramp timer circuit 68 generates a fall edge of the signal T_Vramp_RST.

In addition, the on timer circuit 67[1] generates a rise edge in the signal Ton_RST[1] at time t_{B4} at which the elapsed time t_{EB}[1] reaches the on time Ton (on time Ton of the first channel). At time t_{B4}, the driver 66[1] generates a fall edge in the gate signal GH[1] in response to the rise edge of the signal Ton_RST[1]. The state of the output stage circuit MM[1] is thereby switched from the output high state to the output low state (to be exact, the state of the output stage circuit MM[1] is switched from the output high state through the double off state to the output low state by generating a rise edge in the gate signal GL[1] after the fall edge of the gate signal GH[1]). In addition, the driver 66[1] generates a fall edge in the signal Ton_SET[1] immediately after generating the fall edge in the gate signal GH[1] at time t_{B4} (or substantially at the same time as the fall edge of the gate signal GH[1]). The on timer circuit 67[1] generates a fall edge of the signal Ton_RST[1] in response to the fall edge of the signal Ton_SET[1]. The ramp timer circuit 68 sets half of the on time Ton of the transistor MH in the output stage circuit MM[1] (or a time slightly shorter than the half) as the inversion trigger time Trvs.

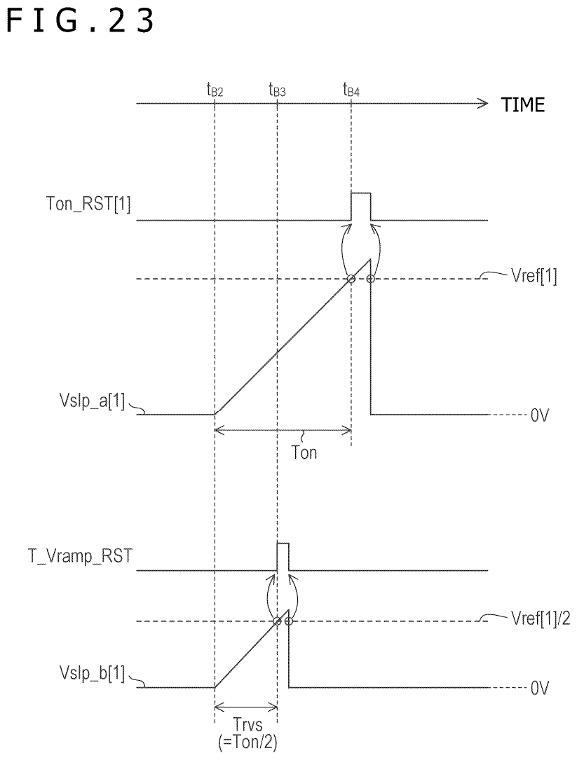

FIG. 23 illustrates the waveforms of signals and voltages within the on timer circuit 67[1] and the ramp timer circuit 68. A slope voltage Vslp_a[1] is generated within the on timer circuit 67[1], and a slope voltage Vslp_b[1] is generated within the ramp timer circuit 68. In addition, a reference voltage Vref[1] is generated and set in the on timer circuit 67[1]. The reference voltage Vref[1] has a positive direct-current voltage value. The on timer circuit 67[1] can adjust the on time Ton of the first channel through adjustment of the reference voltage Vref[1]. A voltage (Vref[1]/2) that is half of the reference voltage Vref[1] set by the on timer circuit 67[1] is supplied to the ramp timer circuit 68. The slope voltages Vslp_a[1] and Vslp_b[1] have 0 V in principle. The on timer circuit 67[1] and the ramp timer circuit 68 monotonically raise the slope voltages Vslp_a[1] and Vslp_b[1] from the occurrence time t_{B2} of the rise edge of the signal Ton_SET[1] (see FIG. 22) at a common and fixed raising rate with 0 V as a starting point.

After time t_{B2}, at time t_{B3} as a time point at which the slope voltage Vslp_b[1] reaches the voltage (Vref[1]/2), the ramp timer circuit 68 generates a rise edge in the signal T_Vramp_RST. The ramp timer circuit 68 sharply decreases the slope voltage Vslp_b[1] to 0 V when a minute time thereafter passes. The decrease of the slope voltage Vslp_b[1] to 0 V is triggered by the fall edge of the signal T_Vramp_SET (see also FIG. 22). The signal T_Vramp_RST indicates a level relation between the slope voltage Vslp_b[1] and the voltage (Vref[1]/2). A fall edge occurs in the signal T_Vramp_RST when the slope voltage Vslp_b[1] falls below the voltage (Vref[1]/2) in a process in which the slope voltage Vslp_b[1] decreases to 0 V.

After time t_{B2}, at time t_{B4} as a time point at which the slope voltage Vslp_a[1] reaches the reference voltage Vref[1], the on timer circuit 67[1] generates a rise edge in the signal Ton_RST[1]. The on timer circuit 67[1] sharply decreases the slope voltage Vslp_a[1] to 0 V when a minute time thereafter passes. The decrease of the slope voltage Vslp_a[1] to 0 V is triggered by the fall edge of the signal Ton_SET[1] (see also FIG. 22). The signal Ton_RST[1] indicates a level relation between the slope voltage Vslp_a[1] and the reference voltage Vref[1]. A fall edge occurs in the signal Ton_RST[1] when the slope voltage Vslp_a[1] falls below the reference voltage Vref[1] in a process in which the slope voltage Vslp_a[1] decreases to 0 V.

The voltage (Vref[1]/2) is half the reference voltage Vref[1]. In addition, the raising rates of the slope voltages Vslp_a[1] and Vslp_b[1] are equal to each other. Therefore, the inversion trigger time Trvs corresponding to a time difference between times t_{B2} and t_{B3} is half the on time Ton of the first channel. The slope voltage Vslp_a[1] can be generated by a constant current circuit and a capacitor charged by a constant current from the constant current circuit. The same is true for the slope voltage Vslp_b[1].

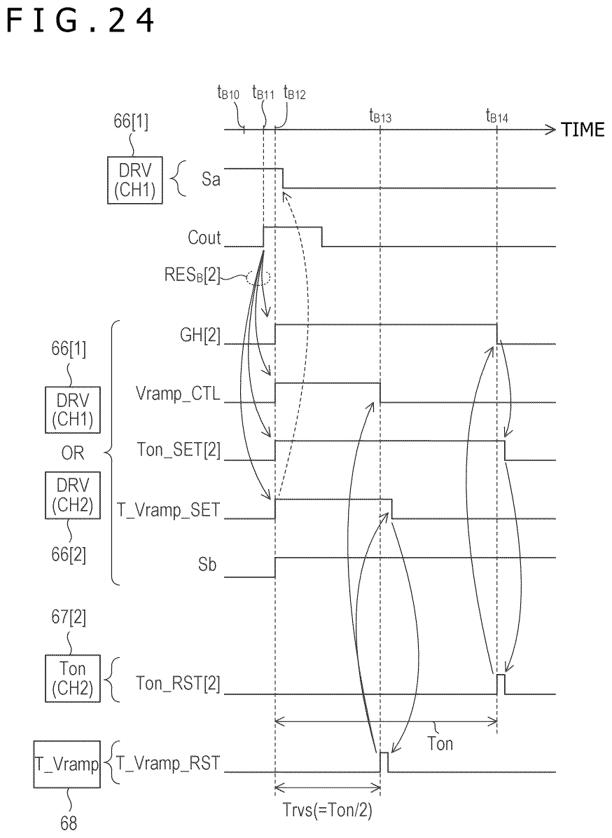

Referring to FIG. 24, a description will be made of an operation of responding to an even-numbered rise edge in the comparison signal Cout. With the passage of time, times t_{B10}, t_{B11}, t_{B12}, t_{B13}, and t_{B14} occur in this order. At time t_{B10}, the order control signal Sa has a high level, and the order control signal Sb has a low level. In addition, at time t_{B10}, all of the signals Cout, GH[2], Vramp_CTL, Ton_SET[2], T_VRAMP_SET, Ton_RST[2], and T_Vramp_RST have a low level. At time t_{B11} immediately after time t_{B10}, an even-numbered rise edge occurs in the comparison signal Cout.

The drivers 66[1] and 66[2] perform a response operation RES_{B}[2] at time t_{B12} in response to the rise edge of the comparison signal Cout at time t_{B11}. Time t_{B12} is a time that is later than time t_{B11} by a circuit delay time, but is substantially equal to time t_{B11}. A part of the response operation RES_{B}[2] is performed by the driver 66[2]. A remaining part of the response operation RES_{B}[2] is performed by the driver 66[1]. The driver 66[2] performs a partial operation of the response operation RES_{B}[2] when a rise edge occurs in the comparison signal Cout while the order control signal input to the driver 66[2] itself has a high level. In the power supply control device 2B illustrated in FIG. 20, the order control signal input to the driver 66[2] is the order control signal Sa, and the order control signal Sa has a high level at time t_{B11}. A partial operation of the response operation RES_{B}[2] is therefore performed in the driver 66[2] in response to the rise edge of the comparison signal Cout at time t_{B11}. The driver 66[1] performs a remaining partial operation of the response operation RES_{B}[2] when a rise edge occurs in the comparison signal Cout while the order control signal input to the driver 66[1] itself has a low level. In the power supply control device 2B illustrated in FIG. 20, the order control signal input to the driver 66[1] is the order control signal Sb, and the order control signal Sb has a low level at time t_{B11}. A remaining partial operation of the response operation RES_{B}[2] is therefore performed in the driver 66[1] in response to the rise edge of the comparison signal Cout at time t_{B11}.

In the partial operation of the response operation RES_{B}[2], the driver 66[2] switches the state of the output stage circuit MM[2] from the output low state or the double off state to the output high state by generating a rise edge in the gate signal GH[2]. In addition, in the partial operation of the response operation RES_{B}[2], the driver 66[2] generates a rise edge in the signal Ton_SET[2], and generates a rise edge also in the order control signal output by the driver 66[2] itself (signal Sb in this case). In the remaining partial operation of the response operation RES_{B}[2], the driver 66[1] generates a rise edge in each of the signals Vramp_CTL and T_Vramp_SET. Incidentally, the driver 66[2] does not perform the partial operation of the response operation RES_{B}[2] even when a rise edge occurs in the comparison signal Cout while the order control signal input to the driver 66[2] (signal Sa in this case) has a low level.

The on timer circuit 67[2] responds to the rise edge of the signal Ton_SET[2] based on the response operation RES_{B}[2], and measures an elapsed time from the timing of the rise edge of the signal Ton_SET[2]. Meanwhile, the ramp timer circuit 68 responds to the rise edge of the signal T_Vramp_SET based on the response operation RES_{B}[2], and measures an elapsed time from the timing of the rise edge of the signal T_Vramp_SET. The respective rise edges of the signals Ton_SET[2] and T_Vramp_SET based on the response operation RES_{B}[2] occur at time t_{B12}. Hence, the on timer circuit 67[2] and the ramp timer circuit 68 both measure an elapsed time from time t_{B12} (which elapsed time will hereinafter be referred to as an elapsed time t_{EB}[2]).

The ramp timer circuit 68 generates a rise edge in the signal T_Vramp_RST at time t_{B13} at which the elapsed time t_{EB}[2] reaches the inversion trigger time Trvs. The driver 66[1] generates a fall edge in the signal Vramp_CTL in response to the rise edge of the signal T_Vramp_RST at time t_{B13}. A rise in the ramp voltage Vramp on the basis of the signal Vramp_CTL at a high level from time ti: therefore ends at time t_{B13}. In addition, when the driver 66[1] receives the rise edge of the signal T_Vramp_RST at time t_{B13}, the driver 66[1] generates a fall edge in the signal T_Vramp_SET after a predetermined minute time. In response to the fall edge of the signal T_Vramp_SET, the ramp timer circuit 68 generates a fall edge of the signal T_Vramp_RST.

In addition, the on timer circuit 67[2] generates a rise edge in the signal Ton_RST[2] at time t_{B14} at which the elapsed time t_{EB}[2] reaches the on time Ton (on time Ton of the second channel). At time t_{B14}, the driver 66[2] generates a fall edge in the gate signal GH[2] in response to the rise edge of the signal Ton_RST[2]. The state of the output stage circuit MM[2] is thereby switched from the output high state to the output low state (to be exact, the state of the output stage circuit MM[2] is switched from the output high state through the double off state to the output low state by generating a rise edge in the gate signal GL[2] after the fall edge of the gate signal GH[2]). In addition, the driver 66[2] generates a fall edge in the signal Ton_SET[2] immediately after generating the fall edge in the gate signal GH[2] at time t_{B14} (or substantially at the same time as the fall edge of the gate signal GH[2]). The on timer circuit 67[2] generates a fall edge of the signal Ton_RST[2] in response to the fall edge of the signal Ton_SET[2]. The ramp timer circuit 68 sets half of the on time Ton of the transistor MH in the output stage circuit MM[2] (or a time slightly shorter than the half) as the inversion trigger time Trvs.

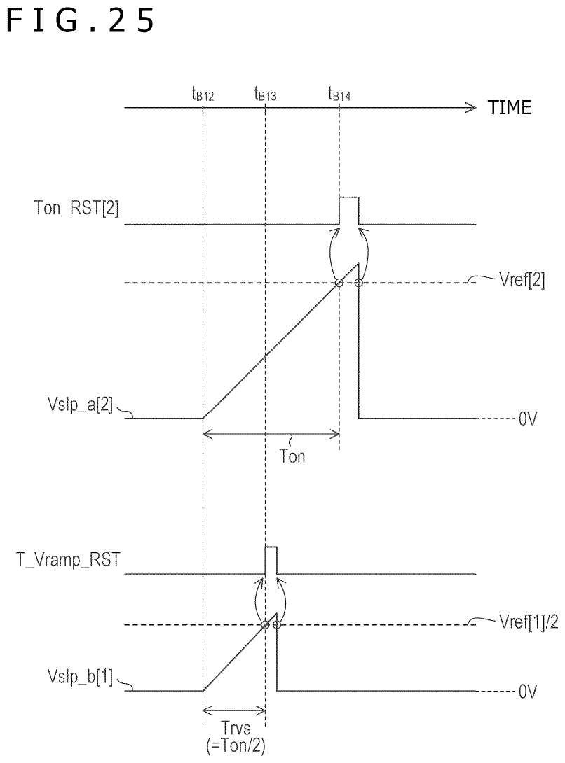

FIG. 25 illustrates the waveforms of signals and voltages within the on timer circuit 67[2] and the ramp timer circuit 68. A slope voltage Vslp_a[2] is generated within the on timer circuit 67[2], and a slope voltage Vslp_b[1] is generated within the ramp timer circuit 68. In addition, a reference voltage Vref[2] is generated and set in the on timer circuit 67[2]. The reference voltage Vref[2] has a positive direct-current voltage value. The on timer circuit 67[2] can adjust the on time Ton of the second channel through adjustment of the reference voltage Vref[2]. The slope voltages Vslp_a[2] and Vslp_b[1] have 0 V in principle. The on timer circuit 67[2] and the ramp timer circuit 68 monotonically raise the slope voltages Vslp_a[2] and Vslp_b[1] from the occurrence time t_{B12} of each of the rise edges of the signals Ton_SET[2] and T_Vramp_SET (see FIG. 24) at a common and fixed raising rate with 0 V as a starting point.

After time t_{B12}, at time t_{B13} as a time point at which the slope voltage Vslp_b[1] reaches the voltage (Vref[1]/2), the ramp timer circuit 68 generates a rise edge in the signal T_Vramp_RST. The ramp timer circuit 68 sharply decreases the slope voltage Vslp_b[1] to 0 V when a minute time thereafter passes. The decrease of the slope voltage Vslp_b[1] to 0 V is triggered by the fall edge of the signal T_Vramp_SET (see also FIG. 24). The signal T_Vramp_RST indicates a level relation between the slope voltage Vslp_b[1] and the voltage (Vref[1]/2). A fall edge occurs in the signal T_Vramp_RST when the slope voltage Vslp_b[1] falls below the voltage (Vref[1]/2) in a process in which the slope voltage Vslp_b[1] decreases to 0 V.

After time t_{B12}, at time t_{B14} as a time point at which the slope voltage Vslp_a[2] reaches the reference voltage Vref[2], the on timer circuit 67[2] generates a rise edge in the signal Ton_RST[2]. The on timer circuit 67[2] sharply decreases the slope voltage Vslp_a[2] to 0 V when a minute time thereafter passes. The decrease of the slope voltage Vslp_a[2] to 0 V is triggered by the fall edge of the signal Ton_SET[2] (see also FIG. 24). The signal Ton_RST[2] indicates a level relation between the slope voltage Vslp_a[2] and the reference voltage Vref[2]. A fall edge occurs in the signal Ton_RST[2] when the slope voltage Vslp_a[2] falls below the reference voltage Vref[2] in a process in which the slope voltage Vslp_a[2] decreases to 0 V.

The raising rates of the slope voltages Vslp_a[1], Vslp_a[2], and Vslp_b[1] are equal to each other (see FIG. 23 and FIG. 25). It can be considered that “Vref[1]=Vref[2]” except for a minute period during a transient response (at least in the steady state) or that “Vref[1]=Vref[2].” The voltage (Vref[1]/2) is therefore half the reference voltage Vref[2]. Hence, the inversion trigger time Trvs corresponding to a time difference between times t_{B12} and t_{B13} is half the on time Ton of the second channel. In addition, when “Vref[1]=Vref[2],” the on time Ton of the first channel and the on time Ton of the second channel are equal to each other. A single reference voltage may be shared as the reference voltages Vref[1] and Vref[2]. The slope voltage Vslp_a[2] can be generated by a constant current circuit and a capacitor charged by a constant current from the constant current circuit. The same is true for the slope voltage Vslp_b[1].

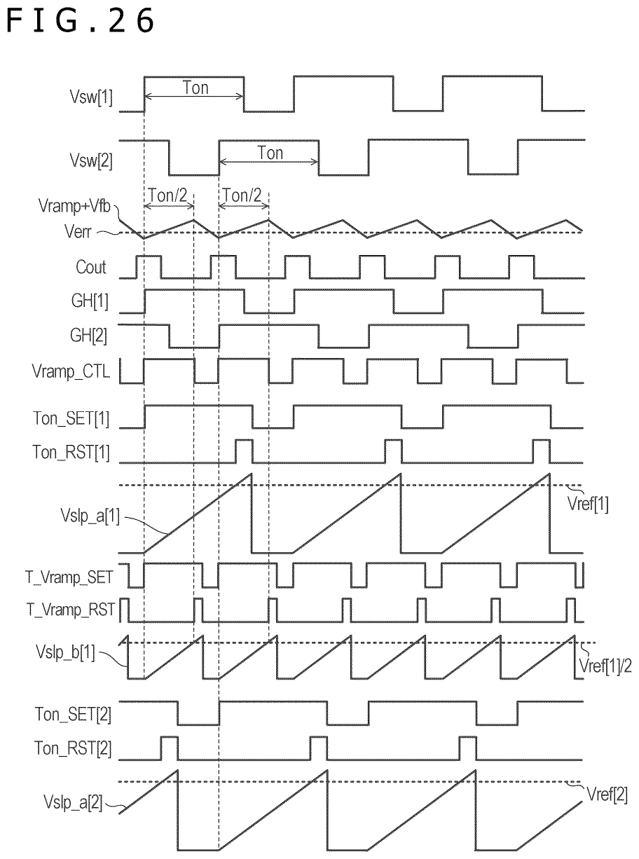

FIG. 26 illustrates a timing diagram of the switching power supply apparatus 1B. Incidentally, FIG. 26 illustrates the switch voltages Vsw[1] and Vsw[2] with the presence of dead times ignored. Illustrated as solid line waveforms in order from an upper side to a lower side of FIG. 26 are the switch voltage Vsw[1], the switch voltage Vsw[2], the combined voltage (Vramp+Vfb), the comparison signal Cout, the gate signal GH[1], the gate signal GH[2], the signal Vramp_CTL, the signal Ton_SET[1], the signal Ton_RST[1], the slope voltage Vslp_a[1], the signal T_Vramp_SET, the signal T_Vramp_RST, the slope voltage Vslp_b[1], the signal Ton_SET[2], the signal Ton_RST[2], and the slope voltage Vslp_a[2]. FIG. 26 illustrates the error voltage Verr, the reference voltage Vref[1], the voltage (Vref[1]/2), and the reference voltage Vref[2] as four broken line waveforms extending in the horizontal direction of the drawing.

FIG. 26 assumes a case where the output voltage Vout is stabilized at the target voltage Vtg in a state in which a sum of the on duty of the first channel and the on duty of the second channel exceeds 100%. The feedback voltage Vfb and the error voltage Verr are held constant in the steady state in which the output voltage Vout is stabilized at the target voltage Vtg. The ramp voltage Vramp changes in the rising direction during a time (Ton/2) from the occurrence of a rise edge in the signal Vramp_CTL in response to a rise edge of the comparison signal Cout. The ramp voltage Vramp otherwise changes in the decreasing direction.

When the output voltage Vout becomes lower than the target voltage Vtg due to an increase in the load current with the state illustrated in FIG. 26 as a starting point, occurrence intervals between rise edges of the comparison signal Cout become smaller than those in the state illustrated in FIG. 26 through a decrease in the feedback voltage Vfb and an increase in the error voltage Verr. As a result, the on duties of the first and second channels become larger than those in the state illustrated in FIG. 26, so that the output voltage Vout increases to the target voltage Vtg. Conversely, when the output voltage Vout becomes higher than the target voltage Vtg due to a decrease in the load current with the state illustrated in FIG. 26 as a starting point, the occurrence intervals between the rise edges of the comparison signal Cout become larger than those in the state illustrated in FIG. 26 through a rise in the feedback voltage Vfb and a decrease in the error voltage Verr. As a result, the on duties of the first and second channels become smaller than those in the state illustrated in FIG. 26, so that the output voltage Vout decreases to the target voltage Vtg. Such feedback control can provide high responsiveness to variation in the load current.

The signal Vramp_CTL functions as a ramp command signal that specifies the changing direction of the ramp voltage Vramp. The state of the signal Vramp_CTL is one of a negated state and an asserted state. The signal Vramp_CTL in an asserted state specifies that the changing direction of the ramp voltage Vramp is to be set as the rising direction. The ramp circuit 41 outputs the ramp voltage Vramp following the contents specified by the ramp command signal (Vramp_CTL). The signal Vramp_CTL in a negated state does not specify that the changing direction of the ramp voltage Vramp is to be set as the rising direction. In the present embodiment, the negated state is associated with the signal Vramp_CTL at a low level, and the asserted state is associated with the signal Vramp_CTL at a high level (however, the association relations thereof can be reversed).

The switching control circuit (66[1], 67[1], 66[2], 67[2], and 68) according to the third embodiment supplies the ramp command signal (Vramp_CTL) to the ramp voltage generating circuit (41) (see FIG. 20). The switching control circuit (66[1], 67[1], 66[2], 67[2], and 68) switches the ramp command signal (Vramp_CTL) from a negated state (low level) to an asserted state (high level) when switching the transistor MH of an optional channel from off to on in response to the switching of the level of the comparison signal Cout from a non-active level (low level) to an active level (high level). The switching control circuit (66[1], 67[1], 66[2], 67[2], and 68) switches the ramp command signal from the asserted state to a negated state when the inversion trigger time Trvs thereafter passes (see FIG. 22 and FIG. 24). The ramp voltage generating circuit (41) sets the changing direction of the ramp voltage Vramp to a first direction in a period in which the ramp command signal is in a negated state, and sets the changing direction of the ramp voltage Vramp to a second direction in a period in which the ramp command signal is in an asserted state. In the present embodiment, the first direction is the decreasing direction, and the second direction is the rising direction.

The third embodiment includes the following examples EX3_1 to EX3_3.

### Example EX3_1

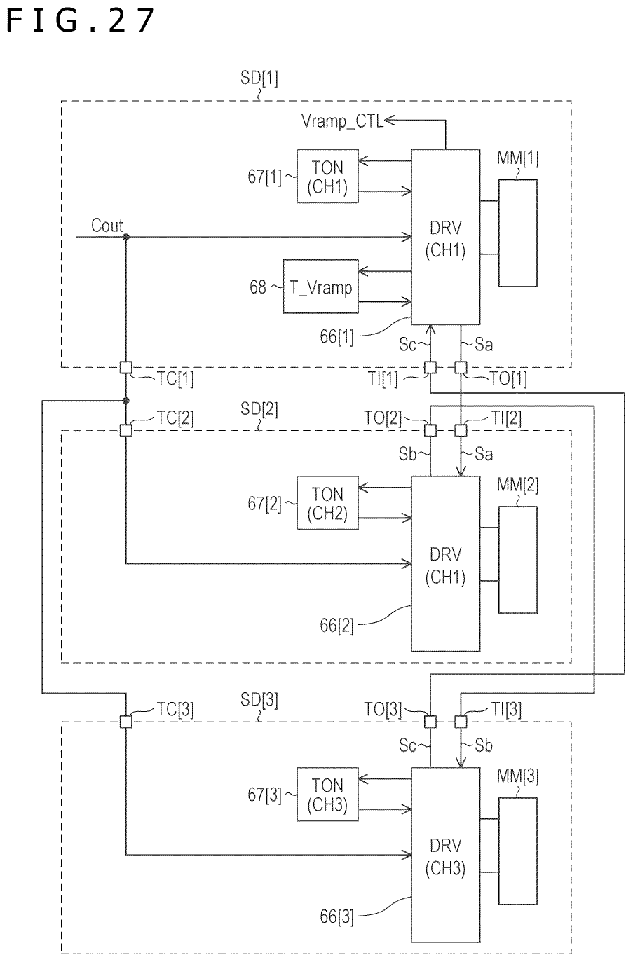

The example EX3_1 will be described. FIG. 20 illustrates the switching power supply apparatus 1 in a case where “n=2” as the switching power supply apparatus 1B. However, as described above, the value of n (the number of channels) is optional as long as the value of n is 2 or more. For example, in a case where “n=3” in the third embodiment, a circuit group for a third channel is added to the switching apparatus 1B illustrated in FIG. 20. The circuit group for the third channel includes a coil L[3] as well as a driver 66[3], an on timer circuit 67[3], and an output stage circuit MM[3] added to the power supply control device 2B in FIG. 20 (see FIG. 27).

FIG. 27 illustrates a partial configuration of the power supply control device 2 (2B) in the case where “n=3.” The power supply control device 2 (2B) in the case where “n=3” is formed by semiconductor devices SD[1] to SD[3] as three electronic parts separated from each other. The semiconductor device SD[3] has the same configuration as the semiconductor device SD[2]. A driver and an on timer circuit provided to the semiconductor device SD[3] so as to correspond to the driver 66[2] and the on timer circuit 67[2] of the semiconductor device SD[2] are the driver 66[3] and the on timer circuit 67[3]. Three cooperation terminals (three external terminals) provided to the semiconductor device SD[3] so as to correspond to the cooperation terminals TI[2], TO[2], and TC[2] of the semiconductor device SD[2] are cooperation terminals TI[3], TO[3], and TC[3]. In the case where “n=3,” external wiring provided outside the semiconductor devices SD[1] to SD[3] establishes a connection between the cooperation terminals TO[1] and TI[2], a connection between the cooperation terminals TO[2] and TI[3], and a connection between the cooperation terminals TO[3] and TI[1], and connects the cooperation terminals TC[1], TC[2], and TC[3] to each other. The comparison signal Cout generated within the semiconductor device SD[1] is supplied to the driver 66[1], and is supplied also to the cooperation terminal TC[1]. The comparison signal Cout generated within the semiconductor device SD[1] is supplied also to the drivers 66[2] and 66[3] via the cooperation terminals TC[1], TC[2], and TC[3].

Operation of the driver 66[3] and the on timer circuit 67[3] is similar to the operation of the driver 66[2] and the on timer circuit 67[2]. The above description made for the operation of the driver 66[2] and the on timer circuit 67[2] is applied also to the driver 66[3] and the on timer circuit 67[3]. At a time of this application, it suffices to read the symbol “[3]” for the symbol “[2]” in the above description made for the operation of the driver 66[2] and the on timer circuit 67[2] as well as the symbol “[2]” associated with the input and output signals of the driver 66[2] and the on timer circuit 67[2].

However, in the case where “n=3,” order control signals Sa, Sb, and Sc are transmitted and received between the drivers 66[1] to 66[3]. As with the order control signals Sa and Sb, the order control signal Sc is a binary signal having a high level or a low level. In the case where “n=3,” through the transmission and reception of the order control signals Sa to Sc, the driver 66[1] performs a response operation RES_{B}[1] in response to only (1+3×m)th rise edges in a group of rise edges in the comparison signal Cout (see FIG. 22). The driver 66[2] performs a partial operation of a response operation RES_{B}[2] in response to only (2+3×m)th rise edges in the group of the rise edges in the comparison signal Cout (see FIG. 24). The driver 66[3] performs a partial operation of a response operation RES_{B}[3] in response to only (3+3×m)th rise edges in the group of the rise edges in the comparison signal Cout. The driver 66[1] performs a remaining partial operation of the response operation RES: [2] in response to the (2+3×m)th rise edges in the group of the rise edges in the comparison signal Cout (see FIG. 24), and performs a remaining partial operation of the response operation RES_{B}[3] in response to the (3+3×m)th rise edges in the group of the rise edges in the comparison signal Cout. m denotes an optional integer of 0 or more. In the case where “n=3,” the order control signal Sa is supplied from the driver 66[1] to the driver 66[2] via the cooperation terminals TO[1] and TI[2], the order control signal Sb is supplied from the driver 66[2] to the driver 66[3] via the cooperation terminals TO[2] and TI[3], and the order control signal Sc is supplied from the driver 66[3] to the driver 66[1] via the cooperation terminals TO[3] and TI[1].

Except for a minute time in a transient state in which the levels of the order control signals Sa to Sc are changed, only one of the order control signals Sa to Sc has a high level, and the other two order control signals have a low level. Then, each time a rise edge occurs in the comparison signal Cout, the order control signal having a high level is changed in order among the order control signals Sa to Sc. In an initial state of the power supply control device 2 (2B) in the case where “n=3,” the order control signal Sc has a high level, and the order control signals Sa and Sb have a low level.

The driver 66[1] performs the response operation RES_{B}[1] when a rise edge occurs in the comparison signal Cout while the order control signal input to the driver 66[1] itself (signal Sc in the configuration of FIG. 27) has a high level. The driver 66[2] performs a partial operation of the response operation RES: [2] when a rise edge occurs in the comparison signal Cout while the order control signal input to the driver 66[2] itself (signal Sa in the configuration of FIG. 27) has a high level. The driver 66[3] performs a partial operation of the response operation RES_{B}[3] when a rise edge occurs in the comparison signal Cout while the order control signal input to the driver 66[3] itself (signal Sb in the configuration of FIG. 27) has a high level. An operation obtained by reading the symbol “[3]” for the symbol “[2]” in the above description made for the partial operation of the response operation RES_{B}[2] corresponds to the partial operation of the response operation RES_{B}[3]. The driver 66[1] performs a remaining partial operation of the response operation RES_{B}[2] or a remaining partial operation of the response operation RES_{B}[3] when a rise edge occurs in the comparison signal Cout while the order control signal input to the driver 66[1] itself (signal Sc in the configuration of FIG. 27) has a low level. The remaining partial operation of the response operation RES_{B}[3] is the same operation as the remaining partial operation of the response operation RES_{B}[2].

In the case where “n=3,” the drivers 66[1] to 66[3], the on timer circuits 67[1] to 67[3], and the ramp timer circuit 68 form the switching control circuit 6 in FIG. 7. The same is true for cases where “n≥4.”

When generalized by supposing that n denotes an optional integer of 2 or more, the switching control circuit 6 and the ramp voltage generating circuit 4 according to the third embodiment can be said to operate as follows. That is, each time the level of the comparison signal Cout switches from a non-active level (low level) to an active level (high level), the switching control circuit 6 according to the third embodiment switches one of the transistors MH of the first to nth channels from off to on, maintains the transistor MH in an on state for the specified on time Ton, and then returns the transistor MH to off. At this time, the switching control circuit 6 changes the transistor MH switched from off to on in order among the transistors MH of the first to nth channels. That is, supposing that the active level is a high level, the switching control circuit 6 switches the transistor MH of a jth channel from off to on in response to a (j+n×m)th rise edge in the comparison signal Cout (j denotes an optional natural number of n or less, and m denotes an optional integer of 0 or more). The switching control circuit 6 including drivers 66[1] to 66[n], on timer circuits 67[1] to 67[n], and the ramp timer circuit 68 supplies the signal Vramp_CTL as a ramp command signal to the ramp voltage generating circuit 4 (41), switches the ramp command signal (Vramp_CTL) from a negated state (low level) to an asserted state (high level) when switching the transistor MH of an optional channel from off to on in response to switching of the level of the comparison signal Cout from a non-active level (low level) to an active level (high level), and then switches the ramp command signal from the asserted state to a negated state when the inversion trigger time Trvs has passed (see FIG. 22 and FIG. 24). The inversion trigger time Trvs is set to be equal to or less than the time (Ton/n). The ramp voltage generating circuit 4 (41) according to the third embodiment sets the changing direction of the ramp voltage Vramp to the first direction (decreasing direction) in a period in which the ramp command signal is in a negated state, and sets the changing direction of the ramp voltage Vramp to the second direction (rising direction) in a period in which the ramp command signal is in an asserted state.

### Example EX3_2

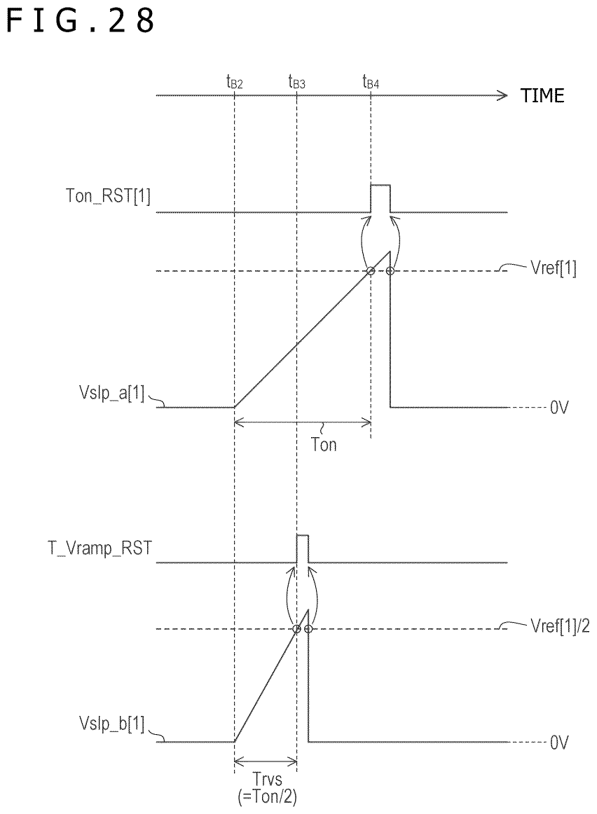

The example EX3_2 will be described. A method of measuring the inversion trigger time Trvs is optional. For example, as illustrated in FIG. 28, after setting the raising rate of the slope voltage Vslp_b[1] to be twice the raising rate of the slope voltage Vslp_a[1], the ramp timer circuit 68 may start to rise the slope voltage Vslp_b[1] from 0 V from time t_{B2} and generate a rise edge in the signal T_Vramp_RST at time t_{B3} as a time point at which the slope voltage Vslp_b[1] reaches the reference voltage Vref[1]. A time that is ½ of the on time Ton of the first channel can be thereby set as the inversion trigger time Trvs. The same is true for the second channel. That is, a time that is ½ of the on time Ton may be set as the inversion trigger time Trvs by setting the raising rate of the slope voltage Vslp_b[1] to be twice the raising rate of the slope voltages Vslp_a[1] and Vslp_a[2].

When generalized by supposing that n denotes an optional integer of 2 or more, it suffices for the ramp timer circuit 68 to operate as follows. That is, it suffices for the ramp timer circuit 68 to make the raising rate of the slope voltage Vslp_b[1] equal to the raising rate of slope voltages Vslp_a[1] to Vslp_a[n], thereafter start to raise the slope voltage Vslp_b[1] from the timing of occurrence of a rise edge in the signal T_Vramp_SET, and set, as the inversion trigger time Trvs, a time from the raising start timing to the reaching of a voltage (Vref[1]/n) by the slope voltage Vslp_b[1] or a time from the raising start timing to the reaching of a voltage lower by a minute voltage than the voltage (Vref[1]/n) by the slope voltage Vslp_b[1].

Alternatively, it suffices for the ramp timer circuit 68 to set the raising rate of the slope voltage Vslp_b[1] to be n times the raising rate of the slope voltages Vslp_a[1] to Vslp_a[n], thereafter start to raise the slope voltage Vslp_b[1] from the timing of occurrence of a rise edge in the signal T_Vramp_SET, and set, as the inversion trigger time Trvs, a time from the raising start timing to the reaching of the reference voltage Vref[1] by the slope voltage Vslp_b[1] or a time from the raising start timing to the reaching of a voltage lower by a minute voltage than the reference voltage Vref[1] by the slope voltage Vslp_b[1].

### Example EX3_3

The example EX3_3 will be described. The power supply control device 2B illustrated in FIG. 20 may be formed by a single semiconductor device SD (see FIG. 11) as a single electronic part. In this case, the respective constituent elements described as being provided in the semiconductor devices SD[1] and SD[2] with reference to FIG. 20 are all provided in the above-described single semiconductor device SD. At this time, the cooperation terminals TO[1], TI[1], TC[1], TO[2], TI[2], and TC[2] are construed as internal nodes provided within the above-described single semiconductor device SD, and pieces of the external wiring WRa, WRb, and WRcmp are construed as internal wiring provided within the above-described single semiconductor device SD. The same is true for cases where “n≥3.”

### Fourth Embodiment

A fourth embodiment of the present disclosure will be described. In the fourth embodiment, a description will be made of a few modified technologies, supplementary items, and the like for the foregoing embodiments.

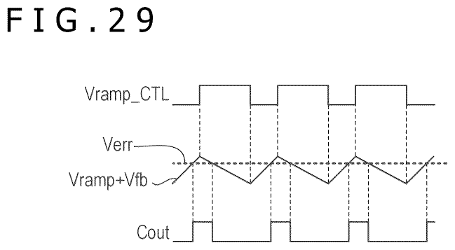

A modification MOD4_1 in which the changing direction of the ramp voltage Vramp is made opposite from that in the above-described examples may be applied to the power supply control device 2A or 2B. At a time of the application of the modification MOD4_1, as illustrated in FIG. 29, the ramp circuit 41 sets the changing direction of the ramp voltage Vramp to the rising direction in a period in which the signal Vramp_CTL is in a negated state (low level), and sets the changing direction of the ramp voltage Vramp to the decreasing direction in a period in which the signal Vramp_CTL is in an asserted state (high level). However, at the time of the application of the modification MOD4_1, the error amplifier 31 is modified such that the error voltage Verr rises in response to establishment of “Vfb>Vref_fb” and the error voltage Verr decreases in response to establishment of “Vfb<Vref_fb,” and the comparator 51 is modified such that the comparison signal Cout has a non-active level (low level) in a period of establishment of “Vramp+Vfb<Verr” and the comparison signal Cout has an active level (high level) in a period of establishment of “Vramp+Vfb>Verr.” Incidentally, it is optional that which of the low level and the high level of the signal Vramp_CTL is assigned to a negated state and an asserted state. It is also optional that which of the low level and the high level of the comparison signal Cout is assigned to a non-active level and an active level.

In addition, with regard to an optional signal or voltage, a relation between the high level and the low level thereof can be made opposite from the above-described relation in such a manner as not to compromise the above-described spirit.

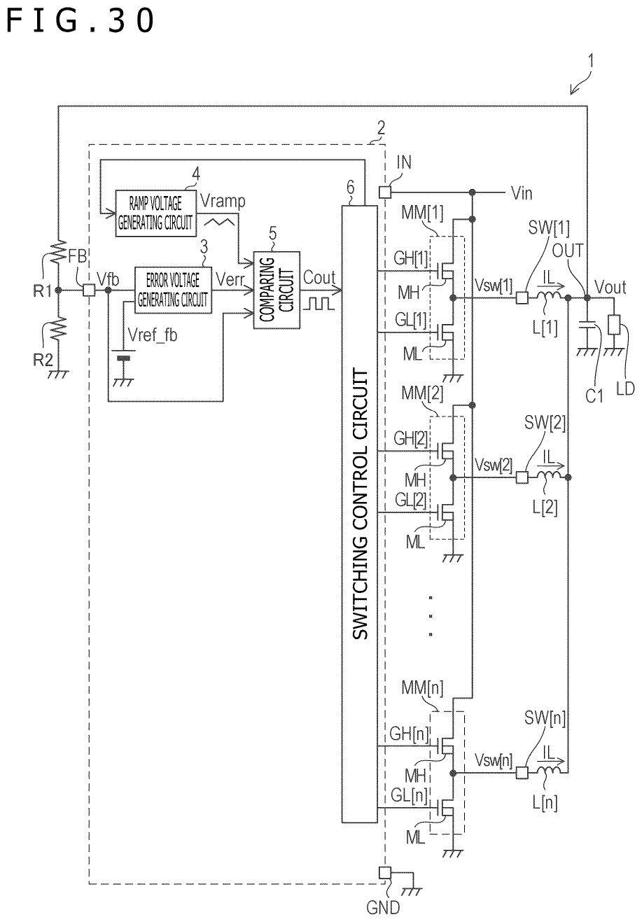

Though repeating the already described items, as illustrated in FIG. 30, the output stage circuits MM[1] to MM[n] may be provided outside the power supply control device 2, and the output stage circuits MM[1] to MM[n] may be connected to the power supply control device 2. That is, the output stage circuits MM[1] and MM[2] may be provided outside the semiconductor device SD in the switching power supply apparatus 1A of FIG. 10, and the output stage circuits MM[1] and MM[2] may be provided outside the semiconductor devices SD[1] and SD[2] in the switching power supply apparatus 1B of FIG. 20.

The switching power supply apparatus (1, 1A, and 1B) illustrated in each embodiment can be mounted in an optional electric apparatus. The electric apparatus may be electric equipment mounted in a vehicle such as an automobile, may be a computer device, or may be a household electric appliance or an industrial apparatus.

The kinds of the channels of the field effect transistors (FETs) illustrated in each of the foregoing embodiments are illustrative. The kind of channel of an optional FET can be changed between the P-channel type and the N-channel type in such a manner as not to compromise the above-described spirit.

As long as no inconvenience occurs, the above-described optional transistors may be transistors of optional kinds. For example, the optional transistor described above as a MOSFET can be replaced with a junction FET, an insulated gate bipolar transistor (IGBT), or a bipolar transistor as long as no inconvenience occurs. The optional transistor has a first electrode, a second electrode, and a control electrode. In a FET, one of the first and second electrodes is a drain, the other is a source, and the control electrode is a gate. In an IGBT, one of the first and second electrodes is a collector, the other is an emitter, and the control electrode is a gate. In a bipolar transistor not belonging to the IGBT, one of the first and second electrodes is a collector, the other is an emitter, and the control electrode is a base.

In the present disclosure, that an optional first physical quantity and an optional second physical quantity are the “same” is construed as a concept including an error. That is, that the first physical quantity and the second physical quantity are the “same” means that a design or a manufacture is made with an aim of making the first physical quantity and the second physical quantity the “same,” and the first physical quantity and the second physical quantity are to be construed as being the “same” even when there is a slight error between the first and second physical quantities. This is true not only for physical quantities, but expressions similar to the “same” (for example, “identical” or “coinciding”) are also to be construed similarly.

The embodiments of the present disclosure can be modified in various manners as appropriate within the scope of technical ideas illustrated in claims. The above embodiments are merely an example of embodiments of the present disclosure, and the meanings of terms of the present disclosure or respective constituent elements are not limited to those described in the above embodiments. Concrete numerical values illustrated in the foregoing description are merely illustrative, and the numerical values can naturally be changed to various numerical values.

### <<Supplementary Notes>>

Supplementary notes will be provided for the present disclosure whose concrete configuration examples have been illustrated in the foregoing embodiments.

The power supply control device according to one aspect of the present disclosure is a power supply control device (2, 2A, or 2B) for use in a switching power supply apparatus (1, 1A, or 1B) configured to generate a plurality of switch voltages (Vsw[1] to Vsw[n]) having a rectangular wave shape at switch terminals (SW[1] to SW[n]) of a plurality of channels by individually switching an input voltage (Vin) by using output stage circuits (MM[1] to MM[n]) of the plurality of channels, the output stage circuits each including an output transistor (MH), and generate an output voltage (Vout) by rectifying and smoothing the plurality of switch voltages and has a configuration (first configuration) including an error voltage generating circuit (3) configured to generate an error voltage (Verr) corresponding to an error between a feedback voltage (Vfb) corresponding to the output voltage and a predetermined reference voltage (Vref_fb), a ramp voltage generating circuit (4) configured to generate a ramp voltage (Vramp) that alternately repeats rising and decreasing, a comparing circuit (5) configured to generate a comparison signal (Cout) having an active level or a non-active level on the basis of a level relation between two voltages based on the error voltage, the ramp voltage, and the feedback voltage, and a switching control circuit (6) configured to sequentially control the output transistors of the plurality of channels to an on state for a specified on time (Ton) while shifting on periods of the output transistors of the plurality of channels from each other on the basis of the comparison signal, the switching control circuit being configured to, each time a level of the comparison signal switches from the non-active level to the active level, switch the output transistor of one of the channels from off to on and return the output transistor to off after the specified on time, and the ramp voltage generating circuit being configured to, each time the level of the comparison signal switches from the non-active level to the active level, switch a changing direction of the ramp voltage from a first direction to a second direction and then switch the changing direction of the ramp voltage from the second direction to the first direction when an inversion trigger time (Trvs) passes, the inversion trigger time being set to be equal to or less than a time (Ton/n) obtained by dividing the specified on time by the number of the channels.

It is thereby possible to perform desired multi-phase control even in a case where timing in which output transistors of two or more channels are simultaneously turned on occur.

The power supply control device according to the first configuration may have a configuration (second configuration) in which the level of the comparison signal switches between the active level and the non-active level each time a level relation between a combined voltage (Vramp+Vfb) of the ramp voltage and the feedback voltage and the error voltage (Verr) is inverted in the comparing circuit.

The power supply control device according to the second configuration (see FIG. 12) may have a configuration (third configuration) in which the error voltage generating circuit decreases the error voltage when the feedback voltage is higher than the reference voltage, and raises the error voltage when the feedback voltage is lower than the reference voltage, the comparison signal has the non-active level when the combined voltage is higher than the error voltage, and has the active level when the combined voltage is lower than the error voltage, and the first direction is a decreasing direction, and the second direction is a rising direction.

The power supply control device according to the second configuration (see FIG. 29) may have a configuration (fourth configuration) in which the error voltage generating circuit raises the error voltage when the feedback voltage is higher than the reference voltage, and decreases the error voltage when the feedback voltage is lower than the reference voltage, the comparison signal has the non-active level when the combined voltage is lower than the error voltage, and has the active level when the combined voltage is higher than the error voltage, and the first direction is a rising direction, and the second direction is a decreasing direction.

5. The power supply control device according to any one of the first to fourth configurations (see FIG. 10) may have a configuration (fifth configuration) in which the plurality of channels are first to nth channels, n denoting an integer of 2 or more, the output stage circuits of the plurality of channels are output stage circuits (MM[1] to MM[n]) of the first to nth channels, each time the level of the comparison signal switches from the non-active level to the active level, the switching control circuit switches one of the output transistors of the first to nth channels from off to on, and maintains the output transistor in an on state for the specified on time, the switching control circuit supplies first to nth ramp command signals (T_Vramp[1] to T_Vramp[n]) each having an asserted state or a negated state to the ramp voltage generating circuit (41 or 42), switches an ith ramp command signal (T_Vramp[i]) from the negated state to the asserted state when switching the output transistor of an ith channel from off to on in response to switching of the level of the comparison signal from the non-active level to the active level, and then switches the ith ramp command signal from the asserted state to the negated state when the inversion trigger time passes, i denoting a natural number of n or less, and the ramp voltage generating circuit sets the changing direction of the ramp voltage to the first direction in a period in which the first to nth ramp command signals are all in the negated state, and sets the changing direction of the ramp voltage to the second direction in a period in which one of the first to nth ramp command signals is in the asserted state.

6. The power supply control device according to any one of the first to fourth configurations (see FIG. 20) may have a configuration (sixth configuration) in which the plurality of channels are first to nth channels, n denoting an integer of 2 or more, the output stage circuits of the plurality of channels are output stage circuits (MM[1] to MM[n]) of the first to nth channels, each time the level of the comparison signal switches from the non-active level to the active level, the switching control circuit switches one of the output transistors of the first to nth channels from off to on, and maintains the output transistor in an on state for the specified on time, the switching control circuit supplies a ramp command signal (T_Vramp_CTL) having an asserted state or a negated state to the ramp voltage generating circuit (41), switches the ramp command signal from the negated state to the asserted state when switching the output transistor of one of the channels from off to on in response to switching of the level of the comparison signal from the non-active level to the active level, and then switches the ramp command signal from the asserted state to the negated state when the inversion trigger time passes, and the ramp voltage generating circuit sets the changing direction of the ramp voltage to the first direction in a period in which the ramp command signal is in the negated state, and sets the changing direction of the ramp voltage to the second direction in a period in which the ramp command signal is in the asserted state.

The power supply control device according to any one of the first to sixth configurations (see FIG. 7) may have a configuration (seventh configuration) in which the output stage circuits of the plurality of channels are provided in the power supply control device.

The power supply control device according to any one of the first to sixth configurations (see FIG. 30) may have a configuration (eighth configuration) in which the output stage circuits of the plurality of channels, the output stage circuits being provided outside the power supply control device, are connected to the power supply control device.

The switching power supply apparatus according to one aspect of the present disclosure (see FIG. 7) is a switching power supply apparatus and has a configuration (ninth configuration) including the power supply control device according to any one of the first to sixth configurations, and a rectifying and smoothing circuit configured to generate the output voltage by rectifying and smoothing the plurality of switch voltages, the output stage circuits of the plurality of channels being provided in the power supply control device.

The switching power supply apparatus according to another aspect of the present disclosure (see FIG. 30) is a switching power supply apparatus and has a configuration (tenth configuration) including the power supply control device according to any one of the first to sixth configurations, the output stage circuits of the plurality of channels, the output stage circuits being connected to the power supply control device, and a rectifying and smoothing circuit configured to generate the output voltage by rectifying and smoothing the plurality of switch voltages.

What is claimed is:

1. A power supply control device for use in a switching power supply apparatus configured to generate a plurality of switch voltages having a rectangular wave shape at switch terminals of a plurality of channels by individually switching an input voltage by using output stage circuits of the plurality of channels, the output stage circuits each including an output transistor, and generate an output voltage by rectifying and smoothing the plurality of switch voltages, the power supply control device comprising:
an error voltage generating circuit configured to generate an error voltage corresponding to an error between a feedback voltage corresponding to the output voltage and a predetermined reference voltage;
a ramp voltage generating circuit configured to generate a ramp voltage that alternately repeats rising and decreasing;
a comparing circuit configured to generate a comparison signal having an active level or a non-active level on a basis of a level relation between two voltages based on the error voltage, the ramp voltage, and the feedback voltage; and
a switching control circuit configured to sequentially control the output transistors of the plurality of channels to an on state for a specified on time while shifting on periods of the output transistors of the plurality of channels from each other on a basis of the comparison signal,
the switching control circuit being configured to, each time a level of the comparison signal switches from the non-active level to the active level, switch the output transistor of one of the channels from off to on and return the output transistor to off after the specified on time, and
the ramp voltage generating circuit being configured to, each time the level of the comparison signal switches from the non-active level to the active level, switch a changing direction of the ramp voltage from a first direction to a second direction and then switch the changing direction of the ramp voltage from the second direction to the first direction when an inversion trigger time passes, the inversion trigger time being set to be equal to or less than a time obtained by dividing the specified on time by the number of the channels.

2. The power supply control device according to claim 1, wherein
the level of the comparison signal switches between the active level and the non-active level each time a level relation between a combined voltage of the ramp voltage and the feedback voltage and the error voltage is inverted in the comparing circuit.

3. The power supply control device according to claim 2, wherein
the error voltage generating circuit decreases the error voltage when the feedback voltage is higher than the reference voltage, and raises the error voltage when the feedback voltage is lower than the reference voltage,
the comparison signal has the non-active level when the combined voltage is higher than the error voltage, and has the active level when the combined voltage is lower than the error voltage, and
the first direction is a decreasing direction, and the second direction is a rising direction.

4. The power supply control device according to claim 2, wherein
the error voltage generating circuit raises the error voltage when the feedback voltage is higher than the reference voltage, and decreases the error voltage when the feedback voltage is lower than the reference voltage,
the comparison signal has the non-active level when the combined voltage is lower than the error voltage, and has the active level when the combined voltage is higher than the error voltage, and
the first direction is a rising direction, and the second direction is a decreasing direction.

5. The power supply control device according to claim 1, wherein
the plurality of channels are first to nth channels, n denoting an integer of 2 or more,
the output stage circuits of the plurality of channels are output stage circuits of the first to nth channels,
each time the level of the comparison signal switches from the non-active level to the active level, the switching control circuit switches one of the output transistors of the first to nth channels from off to on, and maintains the output transistor in an on state for the specified on time,
the switching control circuit supplies first to nth ramp command signals each having an asserted state or a negated state to the ramp voltage generating circuit, switches an ith ramp command signal from the negated state to the asserted state when switching the output transistor of an ith channel from off to on in response to switching of the level of the comparison signal from the non-active level to the active level, and then switches the ith ramp command signal from the asserted state to the negated state when the inversion trigger time passes, i denoting a natural number of n or less, and
the ramp voltage generating circuit sets the changing direction of the ramp voltage to the first direction in a period in which the first to nth ramp command signals are all in the negated state, and sets the changing direction of the ramp voltage to the second direction in a period in which one of the first to nth ramp command signals is in the asserted state.

6. The power supply control device according to claim 1, wherein
the plurality of channels are first to nth channels, n denoting an integer of 2 or more,
the output stage circuits of the plurality of channels are output stage circuits of the first to nth channels,
each time the level of the comparison signal switches from the non-active level to the active level, the switching control circuit switches one of the output transistors of the first to nth channels from off to on, and maintains the output transistor in an on state for the specified on time,
the switching control circuit supplies a ramp command signal having an asserted state or a negated state to the ramp voltage generating circuit, switches the ramp command signal from the negated state to the asserted state when switching the output transistor of one of the channels from off to on in response to switching of the level of the comparison signal from the non-active level to the active level, and then switches the ramp command signal from the asserted state to the negated state when the inversion trigger time passes, and
the ramp voltage generating circuit sets the changing direction of the ramp voltage to the first direction in a period in which the ramp command signal is in the negated state, and sets the changing direction of the ramp voltage to the second direction in a period in which the ramp command signal is in the asserted state.

7. The power supply control device according to claim 1, wherein
the output stage circuits of the plurality of channels are provided in the power supply control device.

8. The power supply control device according to claim 1, wherein
the output stage circuits of the plurality of channels, the output stage circuits being provided outside the power supply control device, are connected to the power supply control device.

9. A switching power supply apparatus comprising:
the power supply control device according to claim 1; and
a rectifying and smoothing circuit configured to generate the output voltage by rectifying and smoothing the plurality of switch voltages,
the output stage circuits of the plurality of channels being provided in the power supply control device.

10. A switching power supply apparatus comprising:
the power supply control device according to claim 1;
the output stage circuits of the plurality of channels, the output stage circuits being connected to the power supply control device; and
a rectifying and smoothing circuit configured to generate the output voltage by rectifying and smoothing the plurality of switch voltages.
